(19) United States
(12) Patent Application Publication
(10) Pub. No.: US 2026/0269850 A1
(43) Pub. Date: Sep. 10, 2026

(54) QUANTIZED PUNCTURED BANDPASS COMPONENTS GENERATION FOR POWER COMBINATION

(71) Applicant: QDAComm LLC, Raleigh, NC (US)

(72) Inventors: Paulo Carvalho, Lisboa (PT); Rui Dinis, Costa da Caparica (PT)

(73) Assignee: QDAComm LLC, Raleigh, NC (US)

(21) Appl. No.: 19/072,650

(22) Filed: Mar. 6, 2025

(51) Int. Cl. H04B 1/04; H04B 1/00

(52) U.S. Cl. CPC H04B 1/04; H04B 1/0007; H04B 2001/0408

(57) ABSTRACT

Systems and methods of performing quantized punctured bandpass components generation for power combination are provided. In one exemplary embodiment, a method is performed by a user equipment device having a set of power amplifier circuitry operable to collectively amplify an input signal having information. The method includes outputting, by a circuitry electrically coupled to the set of power amplifier circuitry, a punctured set of bandpass components that collectively represents a sample of the input signal. Further, the punctured set of bandpass components corresponds to the set of power amplifier circuitry and is associated with a quantized polar representation of the input signal sample.

### FIELD OF DISCLOSURE

The present disclosure relates generally to the field of communications and more specifically to quantized punctured bandpass components generation for power combination.

### BACKGROUND

A fundamental component of a wireless communications system is the transceiver front-end which includes power amplifier circuitry. The transceiver front-end, which can include a digital baseband subsystem and an analog radio frequency (RF) subsystem, can convert digital baseband samples representing an input signal to an analog baseband signal and can then modulate the analog baseband signal and up-convert the modulated signal to an RF carrier. In this process, digital-to-analog converter (DAC) circuitry in the transceiver subsystem can convert the digital baseband samples to the analog baseband signal. In telecommunications systems, improved energy efficiency is a common requirement, especially in wideband communication systems employing single carrier or multicarrier modulations with higher spectral efficiencies (e.g., large constellations), in which envelope fluctuations can compromise power amplification efficiency by a power amplifier (PA) in the transceiver front end. The Background section of this document is provided to place embodiments of the present disclosure in technological and operational context, to assist those of skill in the art in understanding their scope and utility. Unless explicitly identified as such, no statement herein is admitted to be prior art merely by its inclusion in the Background section.

### BRIEF SUMMARY OF THE DISCLOSURE

The following presents a simplified summary of the disclosure in order to provide a basic understanding to those of skill in the art. This summary is not an extensive overview of the disclosure and is not intended to identify key/critical elements of embodiments of the disclosure or to delineate the scope of the disclosure. The sole purpose of this summary is to present some concepts disclosed herein in a simplified form as a prelude to the more detailed description that is presented later.

Briefly described, embodiments of the present disclosure relate to systems and methods of performing quantized punctured bandpass components generation for power combination. According to one aspect, a method can include: receiving the samples sₙ of a baseband signal or the samples of in-phase and quadrature-phase components of a baseband signal, receiving an input clock signal associated with the sampling frequency fₛ=1/T_{S} of the baseband signal, receiving a clock signal associated with an intermediate frequency fᵢ, or receiving a clock signal associated with the carrier frequency f_{c} of the output signal. Further, the method can include receiving, by a quantizer circuitry, the samples of sₙ of a baseband signal sₙ=s(tₙ)=s_{I,n}+js_{Q,n}, with tₙ being the sampling instant. Also, the method can compute the amplitude

$${A}_{n} = \vert {s}_{n} \vert = \sqrt{{s}_{I , n}^{2} + {s}_{Q , n}^{2}} , {α}_{n} = a tan ( {s}_{Q , n} / {s}_{I , n} )$$

of each sample sₙ and can quantize the amplitude Aₙ based on a quantization encoding table representing N_{b} bits, a table with a finite set of quantization values or a table with the discrete amplitudes of quantization components aᵢ={a₁, a₂, . . . , a_{Nb′}}, with N_{b}′=N_{b} or N_{b}′=N_{b}+1, in which the quantized value can be decomposed. The method can also include generating, by the quantizer circuitry, the quantized amplitude A_{qn}=Aₙ+e_{q}, where e_{q} represents the quantization error. The method can further include generating a set of quantization bits that represents the quantized amplitude A_{qn} of the input signal sample and can include computing, based on the quantization error e_{q} a compensation factor Δ belonging to a finite discrete alphabet. The method can further include generating, by a punctured encoder circuitry, a punctured encoding table of the quantization encoding table, which can be applied along with the amplitude Aₙ, the phase αₙ and the set of quantization bits to generate an active set of N′≤N_{b} pairs of in-phase and quadrature-phase mapping components.

According to another aspect, a look up table (LUT) circuitry can be configured to include the punctured mapping table, the quantization encoding table, the sets of discrete amplitudes aᵢ, the set of quantization values, or the like.

According to another aspect, the method can include selecting, by the punctured mapper circuitry, based on the set of quantization bits of the quantized amplitude and the punctured mapping table, the mapping coefficients Cₖ, where k=1, . . . , N_{b′}, with N_{b′}=N_{b} or N_{b′}=N_{b}+1, to enable mapping the quantized value into a maximum number N′≤N_{b} active pairs of in-phase s_{I,n} and quadrature-phase s_{Q,n} components and N′≤N_{b} active mapping components given by Cₖ cos(αₙ) and Cₖ sin(αₙ).

According to another aspect, the maximum number of possible bandpass components and mapping coefficients Cₖ is N_{b}, and coefficients Cₖ assume values from N_{b} discrete alphabets.

According to another aspect, the maximum number of possible bandpass components or mapping coefficients Cₖ is N_{b}+1 for N_{b} quantization bits and coefficients Cₖ can assume values from N_{b}+1 discrete alphabets. Mapping coefficients can be input to a set of bandpass modulator circuitry to generate the punctured set of bandpass components required by the punctured mapper circuitry.

According to another aspect, the punctured mapping rule applied to each quantized value can be applied to generate control information to activate power amplifier circuitry needed to amplify mapping components and the punctured set of bandpass components for each combining element of a combiner circuitry.

According to another aspect, each bandpass modulator circuitry can be implemented by in-phase and quadrature-phase (I/Q) digital to analog converters (I/Q DACs) or implemented by I/Q modulators.

According to another aspect, the punctured mapper can be operable to provide the phase αₙ of each sample to the set of active bandpass modulator circuitry (e.g., I/Q modulators or I/Q DACs) to control the initial phase of the bandpass signals generated by the active set of bandpass modulators for each sampling interval.

According to another aspect, the punctured set of N′ active bandpass components is two (2).

According to another aspect, the maximum number of active bandpass components N′ is always less than the number of quantization bits N_{b} that represent the quantized amplitude of the input signal sample.

According to another aspect, the maximum value of N′ is less than the number of bandpass components N_{b}+1.

According to another aspect, the punctured mapper circuitry can be operable to provide information to control the initial phase of bandpass components generated by a set of bandpass modulator circuitry (e.g., I/Q modulators, I/Q DACs), which can be performed by changing the phases or delays of the inputs of the bandpass modulator circuitry at the beginning of each sampling interval.

According to another aspect, the set of bandpass modulator circuitry can be operable to generate the punctured set of bandpass components at the intermediate frequency fᵢ and the set of mixer circuitry can be operable to up-convert the punctured set of N′ active bandpass components at the carrier frequency f_{c}.

According to another aspect, a punctured encoder circuitry can be operable to determine the amplitude Aₙ and the phase αₙ, quantize the amplitude Aₙ to obtain a quantized amplitude A_{qn}, perform punctured encoding and punctured mapping of the quantized amplitude A_{qn} into components, generate the active set of quantization components, or the like.

### BRIEF DESCRIPTION OF THE DRAWINGS

The present disclosure will now be described more fully hereinafter with reference to the accompanying drawings, in which embodiments of the disclosure are shown. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout.

FIG. 1 illustrates one embodiment of a method of performing quantized punctured bandpass components generation for power combination in accordance with various aspects as described herein.

FIG. 2 illustrates one embodiment of a system of quantized punctured bandpass component generation for power combination in accordance with various aspects as described herein.

FIG. 3 illustrates another embodiment of a system of quantized punctured bandpass component generation for power combination in accordance with various aspects as described herein.

FIG. 4 illustrates another embodiment of a system of quantized punctured bandpass component generation for power combination in accordance with various aspects as described herein.

FIG. 5 illustrates one embodiment of a wireless communication network in accordance with various aspects as described herein.

FIG. 6 illustrates one embodiment of an electronic device in accordance with various aspects as described herein.

### DETAILED DESCRIPTION

For simplicity and illustrative purposes, the present disclosure is described by referring mainly to an exemplary embodiment thereof. In the following description, numerous specific details are set forth in order to provide a thorough understanding of the present disclosure. However, it will be readily apparent to one of ordinary skill in the art that the present disclosure may be practiced without limitation to these specific details.

The present disclosure relates to a quantized digital to analog converter that converts each sample of an input signal into a set of constant envelope bandpass components under a puncturing rule that reduces not only the hardware complexity of the power amplifiers and combiner stage but also enables subsequent improvements of such stage. For example, a puncturing rule can be applied to the quantization bits encoding table to transform it into a punctured mapping table. An embedded de-puncturing can be applied to the coefficients of the mapping table with the introduction of compensation factors that compensate the punctured components or the introduction of additional components needed to obtain a maximum or a constant number of active bandpass components of no more than two active bandpass components. These techniques can enable an improved power combination with an increased energy efficiency for combiner designs.

In another embodiment, by puncturing a quantization encoding table and corresponding mapping table, a punctured set of bandpass components can be generated to improve the energy efficiency trade-off of a set of power amplifier circuitry and the corresponding combiner circuitry. Through punctured mapping, the number of active bandpass components can be fixed or limited to a maximum of two active bandpass components, which enables an improvement of overall efficiency of power combination while reducing the hardware complexity of the combiner circuitry. Further, the application of these punctured mapping generation techniques can reduce or eliminate the need for switch circuitry in the combiner circuitry. In addition, the reduced number of mapping components generated based on the techniques disclosed herein can enable increased energy efficiency of the joint structure of the set of power amplifier circuitry and the combiner circuitry presented herein.

In another embodiment, digital signal processing circuitry can be operable to generate quantized punctured bandpass components that optimize energy efficiency on power amplification or power combination. Further, the digital signal processing circuitry can include receiving the samples sₙ of a baseband signal or the samples of in-phase and quadrature-phase components of a baseband signal, receiving an input clock signal according to the sampling frequency fₛ=1/T_{S} of the baseband signal, a clock signal according to an intermediate frequency fᵢ, receiving a clock signal in accordance with the carrier frequency f_{c} of the output signal, or the like.

In one embodiment, the samples of a baseband input signal can be quantized and decomposed into a number of analog bandpass components based on a punctured mapping rule.

In another embodiment, the input signal can be a baseband signal which is sampled to generate the samples to be converted posteriorly into bandpass components.

In another embodiment, a system can be configured to receive the samples s_{In} and s_{Qn} of the in-phase and quadrature-phase components of a baseband signal.

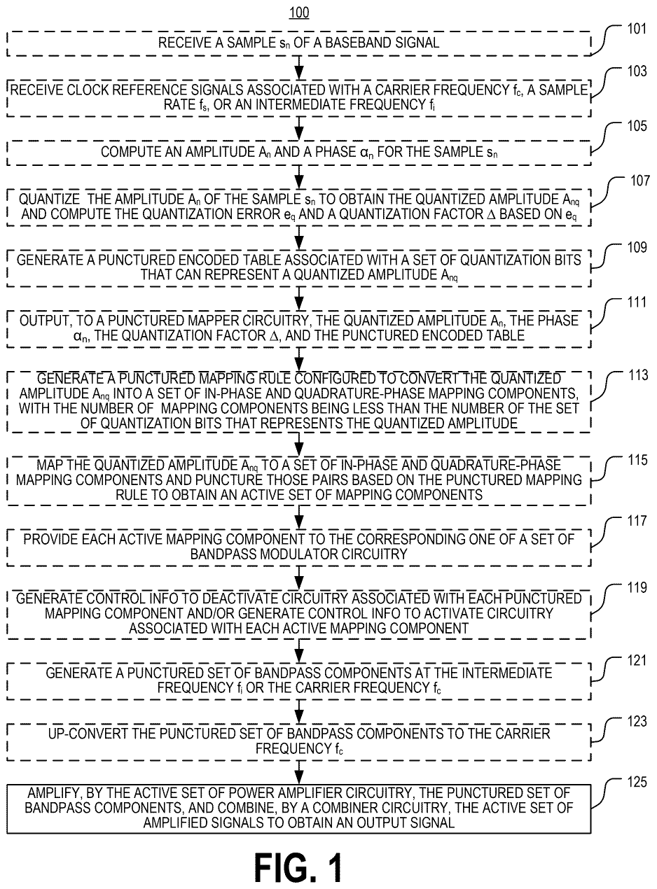

FIG. 1 illustrates one embodiment of a method 100 of performing quantized punctured bandpass components generation for power combination in accordance with various aspects as described herein. For instance, the method 100 can start, for instance, at block 101 where it can include receiving the samples sₙ of a baseband signal. In one example, the method 100 can include sampling, by a sampling circuitry or a sample and hold (S/H) circuitry, a baseband signal to obtain the input signal samples. In another example, the method 100 can include receiving samples of in-phase and quadrature-phase components of a baseband signal. At block 103, the method 100 can include receiving a clock reference having a sampling rate fₛ, receiving a clock reference having a carrier frequency f_{c}, receiving a clock reference having an intermediate frequency fᵢ, or the like. At block 105, the method 100 can include computing the amplitude Aₙ and the phase αₙ for each sample sₙ. At block 107, the method 100 can include quantizing the amplitude Aₙ of each sample sₙ to obtain a set of N_{b} quantization bits that represents the quantized amplitude A_{qn} of that sample sₙ, computing the quantization error e_{q} as the difference between the amplitude Aₙ and the quantized amplitude A_{qn} of each sample sₙ, computing a compensation factor Δ based on the quantization error e_{q}, or the like. At block 109, the method 100 can include generating a punctured encoded table associated with the set of quantization bits that represent the quantized amplitude A_{qn} of each sample sₙ of an input signal. At block 111, the method 100 can include outputting, to a punctured mapper circuitry, the quantized amplitude A_{q}, the phase αₙ, the compensation factor Δ, the punctured encoded table, or the like. At block 113, the method 100 can include generating a punctured mapping rule configured to convert the set of quantization bits that represent the quantized amplitude A_{qn} of the input signal sample sₙ into a set of in-phase and quadrature-phase mapping components associated with a punctured set of N′<N_{b} active bandpass components. The N′<N_{b} active bandpass components represent the punctured set of bandpass components. At block 115, the method 100 can include mapping the set of quantized bits that represents the quantized amplitude A_{qn} of the input signal sample sₙ to a set of in-phase and quadrature-phase mapping components and puncturing that set of mapping components based on the punctured mapping rule to obtain an active set of mapping components. At block 117, the method 100 can include providing each of the active set of mapping components to the corresponding one of a set of bandpass modulator circuitry. At block 119, the method 100 can include generating control information to deactivate circuitry (e.g., bandpass modulator, power amplifier, combining element of a combiner) associated with each punctured (e.g., deactivated) mapping component and/or generate control information to activate circuitry (e.g., bandpass modulator, power amplifier, combining element of a combiner) associated with each active mapping component. At block 121, the method 100 can include generating a punctured set of bandpass components at an intermediate frequency fᵢ or at a carrier frequency f_{c}. At block 123, the method 100 can include up-converting the punctured set of bandpass components to the carrier frequency f_{c}. At block 125, the method 100 includes amplifying, by the active set of power amplifier circuitry, the punctured set of bandpass components, and combining, by the combiner circuitry, the active set of amplified signals to obtain an output signal. For a different number of quantization bits that represents the quantized amplitude of a sample, the punctured mapping rule can change based on the type of power amplifiers or the type of combiner.

In another embodiment, the method steps 105 to 119 can be performed in a single method step.

In another embodiment, the punctured encoding table can be stored in a LUT circuitry so that the method step 105 is no longer needed.

In another embodiment, the method steps 101 to 119 can be implemented in a circuitry having a comparator circuitry and LUT circuitry configured to store the corresponding quantization values, the quantization bits table, the coding puncturing rule, the set of mapping components, control information, or the like.

In another embodiment, successive samples of the input signal that represent a data block can be collectively processed to compute a set of phases an and a set of amplitudes Aₙ of each sample of the data block and can be prior to quantizing the data block.

In another embodiment, the quantization step, the puncture coding step, the punctured mapping step, the control information generating step and the bandpass component generating step can be performed in a single method step.

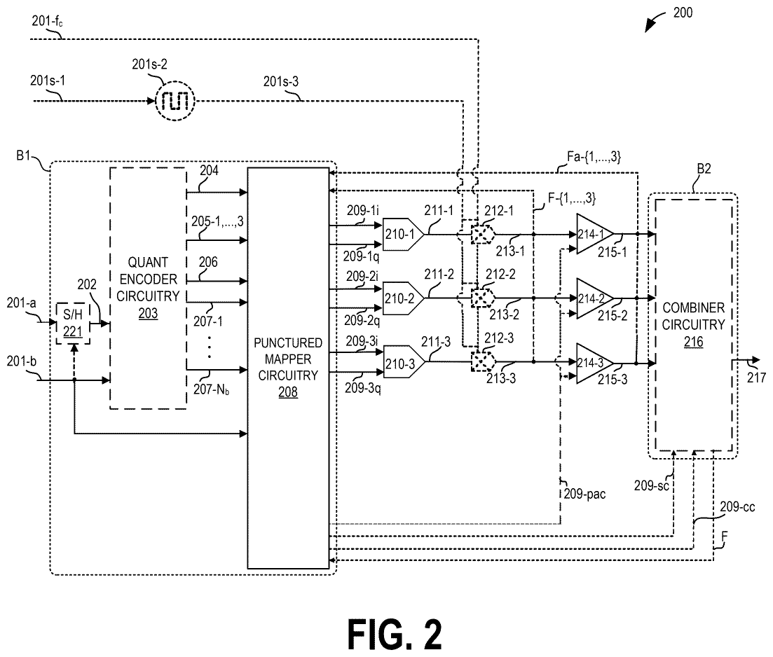

FIG. 2 illustrates one embodiment of a system 200 of quantized punctured bandpass component generation for power combination in accordance with various aspects as described herein. As illustrated in FIG. 2, the number of quantization bits N_{b} of the amplitude Aₙ of the input signal sample is three (3) and a number of N_{b}′=N_{b} is three (3) possible bandpass components. In FIG. 2, the system can be configured to receive an input signal 201-a or time samples sₙ of a baseband signal s(t). Further, the system 200 can be configured to receive a clock reference signal 201-b having the sampling frequency fₛ, a clock reference signal 201s-1 having an intermediate frequency fᵢ, a reference signal clock 201-f_{c} having a carrier frequency f_{c}, or the like. A skilled artisan will recognize that the selection of a clock reference signal can be based on the bandwidth of an input signal, the desired frequency of an output signal, the frequency to up-convert bandpass components, or the like.

In another embodiment, the input signal 201-a can include the samples s_{In} and s_{Qn} of the in-phase and quadrature-phase components of a baseband signal.

In another embodiment, a sampling circuitry or sample and hold circuitry 221 can be operable to sample the input signal 201-a to obtain the time samples sₙ=s(tₙ).

In FIG. 2, the clock signal 201-b can be a clock reference signal having the sampling frequency for input to the sampling circuitry or the sample and hold circuitry 221, a quantization encoder circuitry 203, a punctured mapper circuitry 208, a combiner circuitry 216, or the like. The quantizer encoder circuitry 203 can be operable to receive the sample sₙ 202 of the input signal s(t) 201-a, compute the amplitude

$${A}_{n} = \vert {s}_{n} \vert = \sqrt{{s}_{I , n}^{2} + {s}_{Q , n}^{2}} ,$$

and the phase αₙ=atan(s_{Q,n}/s_{I,n}) of the sample sₙ 202. The quantizer encoder circuitry 203 can be configured to include a quantization encoding table that represents a set of N_{b} quantization bits for each quantized amplitude of a sample sₙ 202, a table having a finite set of quantization values that correspond to the set of N_{b} quantization bits, a table having the sets of discrete amplitudes of quantization components aᵢ={a₁, a₂, . . . , a_{N}} in which the quantized value can be decomposed, the set of quantized values, or the like. The quantization encoding table can be represented such as by:

Quantization Encoding Table

| Bit 3 | Bit 2 | Bit 1 |
|---|---|---|
| 0 | 0 | 0 |
| 0 | 0 | 1 |
| 0 | 1 | 0 |
| 0 | 1 | 1 |
| 1 | 0 | 0 |
| 1 | 0 | 1 |
| 1 | 1 | 0 |
| 1 | 1 | 1 |

The quantizer encoder circuitry 203 can be operable to quantize the amplitude Aₙ of each sample, generate the quantized amplitude A_{qn}=Aₙ+e_{q} and the set of quantization bits 207-{1, . . . , N_{b}} that represents the quantized amplitude A_{qn}, and compute a compensation factor Δ belonging to a finite discrete alphabet based quantization error e_{q}. The quantizer encoder circuitry 203 can also be operable to generate a punctured encoding table and output, to the punctured mapper circuitry 208, a signal 204 that represents the punctured encoding table.

The quantizer encoder circuitry 203 can also be operable to output, to the punctured mapper circuitry 208, the set of quantization bits 207-{1, . . . , N_{b}}, signals 205-{1, . . . , 3} that includes a representation of the amplitude Aₙ, the phase αₙ and the compensation factor Δ, a signal 206 that represents discrete amplitudes of quantization components aᵢ, or the like. The punctured mapper circuitry 208 can be operable to generate an active set of N′≤N_{b} pairs of in-phase and quadrature-phase mapping components based on a punctured mapping table that can be stored in a LUT circuitry that includes the mapping component values based on a puncturing rule.

In one example, the punctured mapping table can include the quantization bit combinations, the sets of discrete amplitudes aᵢ, the set of quantized values, or the like. The punctured mapper circuitry 208 can be operable to select the mapping values of the corresponding mapping components based on the punctured mapping table such as represented by:

Mapping Components with Puncturing

| C₃ | C₂ | C₁ |
|---|---|---|
| ${C}_{3}^{( 1 )}$ | ${C}_{2}^{( 1 )}$ | ${C}_{1}^{( 1 )}$ |
| ${C}_{3}^{( 2 )}$ | ${C}_{2}^{( 2 )}$ | ${C}_{1}^{( 2 )}$ |
| ${C}_{3}^{( 3 )}$ | ${C}_{2}^{( 3 )}$ | ${C}_{1}^{( 3 )}$ |
| ${C}_{3}^{( 4 )}$ | ${C}_{2}^{( 4 )}$ | ${C}_{1}^{( 4 )}$ |
| ${C}_{3}^{( 5 )}$ | ${C}_{2}^{( 5 )}$ | ${C}_{1}^{( 5 )}$ |
| ${C}_{3}^{( 6 )}$ | ${C}_{2}^{( 6 )}$ | X |
| ${C}_{3}^{( 7 )}$ | ${C}_{2}^{( 7 )}$ | ${C}_{1}^{( 6 )}$ |
| ${C}_{3}^{( 8 )}$ | ${C}_{2}^{( 8 )}$ | X |

The coefficients Cₖ, k=1, . . . , N_{b}, needed to map the quantized value into a set of N_{b} pairs of in-phase s_{I,n} and quadrature-phase s_{Q,n} mapping components 209-{1ᵢ, . . . , 3ᵢ} and 209-{1_{q}, . . . , 3_{q}}, can be given by Cₖ cos(αₙ) and Cₖ sin(αₙ), and where ‘X’ represents puncturing. C₁ mapping coefficient can assume values from a set of amplitudes

$${C}_{1}^{( i )} ,$$

i=1, . . . , 6 that belong to a discrete alphabet A₁={0, Δ, a₁+Δ, a₁+k_{1,1}}, where Δ is the discrete compensation factor with values belonging to a discrete and finite alphabet. Coefficient k_{1,1} is defined to enable an improved power relationship between components to improve the trade-off between power amplification and combination efficiency and assume different values belonging to a discrete and limited set of possible values. C₂ mapping coefficient can assume values from a set of amplitudes

$${C}_{2}^{( i )} ,$$

i=1, . . . , 8, belonging to a discrete alphabet A₂={0, a₂+Δ, a₂+k_{2,1}Δ, a₂+k_{2,2}Δ, a₂+k_{2,3}Δ+k_{2,4}a₁}, with coefficients k_{2,1}, k_{2,2}, k_{2,3} and k_{2,4} defined according the same criteria applied in definition of previous coefficients k_{1,1}. C₃ mapping coefficient assume values from a set of amplitudes

$${C}_{3}^{( i )} ,$$

i=1, . . . , 8, belonging to a discrete alphabet A₃={0, a₃+Δ, a₃+k_{3,1}Δ+k_{3,2}a₁, a₃+k_{3,3}Δ, a₃+k_{3,4}Δ+k_{3,5}a₁}, where Δ is the compensation factor with values belonging to a discrete and finite alphabet. Coefficients k_{3,1}, k_{3,2}, k_{3,3}, k_{3,4} and k_{3,5} can be defined to enable an improved power relationship between components to improve the trade-off between power amplification and combination efficiency and assume different values always belonging to a discrete and limited set of possible values.

In another example, the punctured encoding table and the equivalent mapping with component puncturing can be represented by the table below:

| Equivalent Bit Coding | | | | | |
|---|---|---|---|---|---|
| with Bit Puncturing | | | Equivalent Mapping with Component Puncturing | | |
| Bit 3 | Bit 2 | Bit 1 | C₃ | C₂ | C₁ |
| 0 | 0 | 0 | 0 | 0 | 0 |
| 0 | 0 | 1 | 0 | 0 | a₁ + Δ |
| 0 | 1 | 0 | 0 | a₂ + Δ | 0 |
| 0 | 1 | 1 | 0 | ${a}_{2} + \frac{{a}_{2}}{{a}_{2} + {a}_{1}} Δ$ | ${a}_{1} + \frac{{a}_{1}}{{a}_{2} + {a}_{1}} Δ$ |
| 1 | 0 | 0 | a₃ + Δ | 0 | 0 |
| 1 | 0 | 1 | ${a}_{3} + \frac{{a}_{3}}{{a}_{3} + {a}_{1}} Δ$ | 0 | ${a}_{1} + \frac{{a}_{1}}{{a}_{3} + {a}_{1}} Δ$ |
| 1 | 1 | 0 | ${a}_{3} + \frac{{a}_{3}}{{a}_{3} + {a}_{2}} Δ$ | ${a}_{2} + \frac{{a}_{2}}{{a}_{3} + {a}_{2}} Δ$ | 0 |
| 1 | 1 | X | ${a}_{3} + \frac{{a}_{3}}{{a}_{3} + {a}_{2}} ( Δ + {a}_{1 )}$ | ${a}_{2} + \frac{{a}_{2}}{{a}_{3} + {a}_{2}} ( Δ + {a}_{1 )}$ | X |

In the table above, ‘X’ denotes the punctured bits, Δ represents the quantized quantization noise and aᵢ, i=1, 2, 3 represents the amplitudes of mapping components. C₁ component amplitudes can belong to a finite alphabet with possible values of

$$\{ 0 , Δ , {a}_{1} + Δ , {a}_{1} + \frac{{a}_{1}}{{a}_{2} + {a}_{1}} Δ , {a}_{1} + \frac{{a}_{1}}{{a}_{3} + {a}_{1}} Δ \} . {C}_{2}$$

component amplitudes can belong to a finite alphabet with possible values of

$$\{ 0 , {a}_{2} + Δ , {a}_{2} + \frac{{a}_{2}}{{a}_{2} + {a}_{1}} Δ , {a}_{2} + \frac{{a}_{2}}{{a}_{3} + {a}_{2}} Δ , {a}_{2} + \frac{{a}_{2}}{{a}_{3} + {a}_{2}} ( Δ + {a}_{1} ) \} .$$

C₃ component amplitudes can belong to a finite alphabet with possible values of

$$\{ 0 , {a}_{3} + Δ , {a}_{3} + \frac{{a}_{3}}{{a}_{3} + {a}_{1}} Δ , {a}_{3} + \frac{{a}_{3}}{{a}_{3} + {a}_{2}} Δ , {a}_{3} + \frac{{a}_{3}}{{a}_{3} + {a}_{2}} ( Δ + {a}_{1} ) \} ,$$

where Δ is a discrete correction factor with values belonging to a discrete and finite alphabet. Amplitudes a₁, a₂, a₃ and a₄ can be defined to enable a preferable power relation between components to increase the combination efficiency at the combiner circuitry and can assume different values belonging to a discrete and limited set of possible values for each combiner type.

In another embodiment, a LUT circuitry can be configured to store the punctured mapping table, the punctured coding table, the quantization encoding table, the quantization values table, the quantization amplitude components table, or the like. Further, the punctured encoder circuitry 203 or the punctured mapper circuitry 208 can be operable to access the information stored in the LUT circuitry.

In another embodiment, a single LUT circuitry can include the punctured mapping table, the punctured coding table, the quantization encoding table, the quantization values table, the quantization amplitude components table, or the like.

In FIG. 2, the punctured mapper circuitry 208 can be operable to provide the active set of N′≤N_{b} pairs of in-phase and quadrature-phase mapping components 209-{1, . . . , 3} and 209-{1_{q}, . . . , 3_{q}}, to a set of N′ bandpass modulator circuitry 210-{1, . . . , 3}(e.g., I/Q DACs, I/Q modulators) operable to generate a punctured set of bandpass components 211-{1, . . . , 3}. The set of power amplifier circuitry 214-{1, . . . , 3} can be operable to amplify the punctured set of bandpass signals 213-{1, . . . , 3} to obtain a punctured set of amplified signals 215-{1, . . . , 3}. The combiner circuitry 216 can be operable to combine the punctured set of amplified signals 215-{1, . . . , 3} to obtain the output signal 217.

In another embodiment, without the set of mixer circuitry 212-{1, . . . , 3}, the set of bandpass modulator circuitry 210-{1, . . . , 3} can be operable to generate the set of bandpass components 213-{1, . . . , 3} having the carrier frequency f_{c}.

In another embodiment, the punctured mapper circuitry 208 can also be operable to generate control information to active or deactivate the set of mixer circuitry 212-{1, . . . , 3}, control the set of power amplifier circuitry 214-{1, . . . , 3} associated with the active set of mapping components, control the combiner circuitry 216, or the like.

In another embodiment, the punctured mapper circuitry 208 can be operable to output, to the active set of bandpass modulator circuitry 210-{1, . . . , 3}, the phase αₙ of each sample to control the initial phase of the bandpass signals 213-{1, . . . , 3} generated by the set of bandpass modulator circuitry 210-{1, . . . , 3}.

In another embodiment, the set of bandpass modulator circuitry 210-{1, . . . , N_{b}} can be operable to generate a punctured set of N′ active bandpass components at the intermediate frequency fᵢ and the set of mixer circuitry 212-{1, . . . , 3} can be operable to up-convert the punctured set of bandpass components to the carrier frequency f_{c}.

In another embodiment, the punctured mapper circuitry 208 can be operable to generate control information 209-pac for power amplifier activation or deactivation and control information 209-cc to control the combiner circuitry 216 of circuitry block B2. The combiner circuitry 216 can be resistive, hybrid, Wilkinson, transformer based, based on voltage or current combining after transform matching, an impedance matching network, or the like.

In FIG. 2, an oscillator circuitry 201s-2 can be configured to receive a signal 201s-1 having a reference frequency. For example, the reference frequency can be a carrier frequency f_{c}, an intermediate frequency fᵢ, a frequency associated with up-conversion from an intermediate frequency fᵢ to a carrier frequency f_{c}, or the like. When the signal 201s-1 includes an intermediate frequency fᵢ, the oscillator circuitry 201s-2 can be operable to generate a reference sinusoidal signal 201s-3 for input to the set of mixer circuitry 212-{1, . . . , 3} to enable up-conversion of the punctured set of bandpass signals 213-{1, . . . , 3} to an intermediate frequency fᵢ.

In another embodiment, the punctured mapper circuitry 208 can be operable to receive, from the set of bandpass modulator circuitry 210-{1, . . . , 3}, feedback signals F-{1, . . . , 3} to generate time or phase control information for the set of bandpass modulator circuitry 210-{1, . . . , 3} to enable time or phase synchronization of the punctured set of bandpass components 211-{1, . . . , 3}.

In another embodiment, the punctured mapper circuitry 208 can be operable to receive, from the set of mixer circuitry 212-{1, . . . , 3}, feedback signals F-{1, . . . , 3} to generate time or phase control information to enable time or phase synchronization of the punctured set of bandpass components 213-{1, . . . , 3}.

In another embodiment, the punctured mapper circuitry 208 can be operable to receive, from the set of power amplifier circuitry 214-{1, . . . , 3}, feedback signals Fa-{1, . . . , 3} to generate time or phase control information to enable time or phase synchronization of the punctured set of amplified signals 215-{1, . . . , 3}.

In another embodiment, the system 200 can be configured to receive the reference clock signal 201s-1 having an intermediate frequency fᵢ for input to the set of bandpass modulator circuitry 210-{1, . . . , 3}. Further, the system 200 can be configured to receive the clock signal 201-f_{c} having the carrier frequency f_{c} for input to the set of mixer circuitry 212-{1, . . . , 3} operable to up-convert the punctured set of bandpass components 211-{1, . . . , 3}.

In another embodiment, circuitry B1 can be configured to include the sampling circuitry 221, the punctured mapper circuitry 208, the quantizer encoder circuitry 203, or the like. Further, the circuitry B1 can be implemented in a single circuitry block with hardware, software or firmware, including digital or analog techniques, and with or without microprocessors, field programmable gate arrays (FPGAs) or digital signal processors (DSPs).

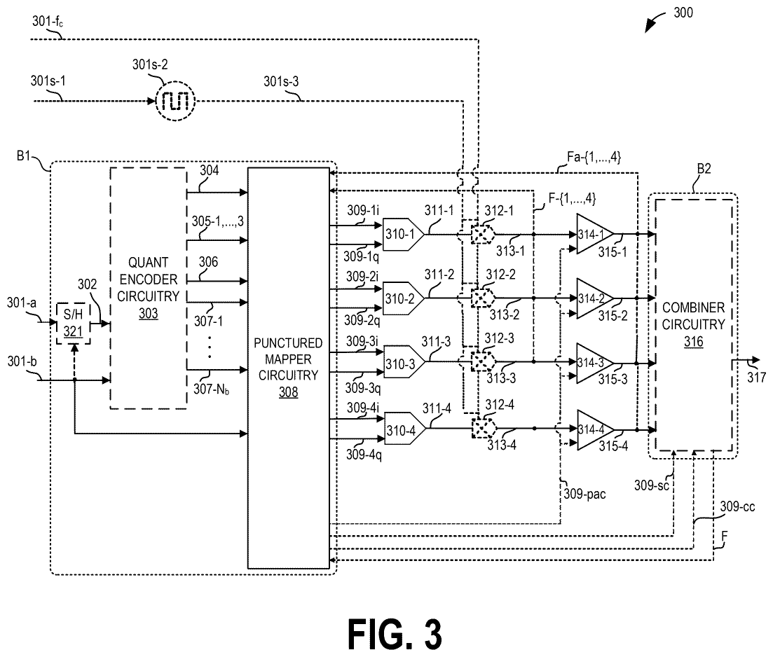

FIG. 3 illustrates another embodiment of a system 300 of quantized punctured bandpass components generation for power combination in accordance with various aspects as described herein. As illustrated in FIG. 3, the number of quantization bits N_{b} of the amplitude Aₙ of the input signal sample is three (3) and a number of N_{b}′=N_{b}+1 is four (4) possible bandpass components. In FIG. 3, the system can be configured to receive an input signal 301-a or time samples sₙ of a baseband signal. Further, the system 300 can be configured to receive a clock reference signal 301-b having a sampling frequency fₛ, a clock reference signal 301s-1 having an intermediate frequency fᵢ, a reference signal clock 301-f_{c} having a carrier frequency f_{c}, or the like. A skilled artisan will recognize that the selection of a clock reference signal can be based on the bandwidth of an input signal, a desired frequency of an output signal, the frequency to up-convert bandpass components, or the like.

In another embodiment, the input signal 301-a can include the samples s_{In} and s_{Qn} of the in-phase and quadrature-phase components of a baseband signal.

In another embodiment, a sampling circuitry or a sample and hold circuitry 321 can be operable to sample the input signal 301-a to obtain the time samples s_{In}=s(tₙ).

In FIG. 3, the clock signal 301-b can be a clock reference signal having a sampling frequency for input to a sampling circuitry 321, a quantization encoder circuitry 303, a punctured mapper circuitry 308, a combiner circuitry 316, or the like. The quantizer encoder circuitry 303 can be operable to receive the samples sₙ 302 of the input signal s(t) 301-a, compute the amplitude

$${A}_{n} = \vert {s}_{n} \vert = \sqrt{{s}_{I , n}^{2} + {s}_{Q , n}^{2}} ,$$

and the phase αₙ=atan(s_{Q,n}/s_{I,n}) of the samples sₙ 302. The quantizer encoder circuitry 303 can be configured to include a quantization encoding table having N_{b} quantization bits for each quantized value, a table having a finite set of quantization values, a table having the sets of discrete amplitudes of quantization components aᵢ={a₁, a₂, . . . , a_{Nb}+1} in which the quantized value can be decomposed, the set of quantized values, or the like. The quantizer encoder circuitry 303 can be operable to quantize the amplitude Aₙ of each sample, generate the quantized amplitude A_{qn}=Aₙ+e_{q} and the set of quantization bits 307-{1, . . . , N_{b}} that represents the quantized amplitude A_{qn}, compute a compensation factor Δ belonging to a finite discrete alphabet based quantization error e_{q}, or the like. The quantization encoding table can be represented such as by:

Binary Quantization Mapping Table

| Bit 4 | Bit 3 | Bit 2 | Bit 1 |
|---|---|---|---|
| 0 | 0 | 0 | 0 |
| 0 | 0 | 0 | 1 |
| 0 | 0 | 1 | 0 |
| 0 | 0 | 1 | 1 |
| 0 | 1 | 0 | 0 |
| 0 | 1 | 0 | 1 |
| 0 | 1 | 1 | 0 |
| 0 | 1 | 1 | 1 |
| 1 | 0 | 0 | 0 |
| 1 | 0 | 0 | 1 |
| 1 | 0 | 1 | 0 |
| 1 | 0 | 1 | 1 |
| 1 | 1 | 0 | 0 |
| 1 | 1 | 0 | 1 |
| 1 | 1 | 1 | 0 |
| 1 | 1 | 1 | 1 |

The quantizer encoder circuitry 303 can also be operable to generate a punctured encoding table and output, to the punctured mapper circuitry 308, a signal 304 that represents the punctured encoding table. The quantizer encoder circuitry 303 can also be operable to output, to the punctured mapper circuitry 308, the set of quantization bits 307-{1, . . . , N_{b}}, signals 305-{1, . . . , 3} that includes a representation of the amplitude Aₙ, the phase αₙ and the compensation factor Δ, a signal 306 that represents discrete amplitudes of quantization components aᵢ, or the like. The punctured mapper circuitry 308 can be operable to generate an active set of N′≤N_{b}+1 pairs of in-phase and quadrature-phase mapping components based on a punctured mapping table that can be stored in a LUT circuitry that includes the mapping component values based on a puncturing rule. Further, the punctured mapper circuitry 308 can be operable to select the mapping values of the corresponding mapping components based on the punctured mapping table such as represented by:

Equivalent Mapping with Component Puncturing

| C₄ | C₃ | C₂ | C₁ |
|---|---|---|---|
| ${C}_{4}^{( 1 )}$ | ${C}_{3}^{( 1 )}$ | ${C}_{2}^{( 1 )}$ | ${C}_{1}^{( 1 )}$ |
| ${C}_{4}^{( 2 )}$ | ${C}_{3}^{( 2 )}$ | ${C}_{2}^{( 2 )}$ | ${C}_{1}^{( 2 )}$ |
| ${C}_{4}^{( 3 )}$ | ${C}_{3}^{( 3 )}$ | ${C}_{2}^{( 3 )}$ | ${C}_{1}^{( 3 )}$ |
| ${C}_{4}^{( 4 )}$ | ${C}_{3}^{( 4 )}$ | ${C}_{2}^{( 4 )}$ | X |
| ${C}_{4}^{( 5 )}$ | ${C}_{3}^{( 5 )}$ | ${C}_{2}^{( 5 )}$ | ${C}_{1}^{( 5 )}$ |
| ${C}_{4}^{( 6 )}$ | ${C}_{3}^{( 6 )}$ | ${C}_{2}^{( 6 )}$ | X |
| ${C}_{4}^{( 7 )}$ | ${C}_{3}^{( 7 )}$ | ${C}_{2}^{( 7 )}$ | ${C}_{1}^{( 6 )}$ |
| ${C}_{4}^{( 8 )}$ | ${C}_{3}^{( 8 )}$ | X | X |

In the table above, the mapping coefficients Cₖ, k=1, . . . , N_{b}+1, needed to map the quantized value into N_{b}+1 pairs of in-phase s_{I,n} and quadrature-phase s_{Q,n} mapping components 309-{i₁, . . . , i_{Nb+1}} and 309-{q₁, . . . , q_{Nb+1}}, can be given by Cₖ cos(αₙ) and Cₖ sin(αₙ). C₁ mapping coefficient can assume values from a set of amplitudes

$${C}_{1}^{( i )} ,$$

i=1, . . . , 6 belonging to a discrete alphabet A₁={0, k_{1,1}Δ, k_{1,2}a₁+k_{1,3}Δ} and coefficients k_{1,1}, k_{1,2} and k_{1,3} are defined to enable an improved power relationship between components to improve the trade-off between power amplification and combination efficiency and assume different values belonging to a discrete and limited set of possible values. C₂ mapping coefficient can assume values from a set of amplitudes

$${C}_{2}^{( i )} ,$$

i=1, . . . , 7, belonging to a discrete alphabet A₂={0, k_{2,1}Δ, k_{2,2}a₁+k_{2,3}Δ, k_{2,4}a₁+k_{2,5}Δ, k_{2,6}a₁+k_{2,7}Δ, k_{2,8}a₁+k_{2,9}Δ, k_{2,10}a₁+k_{2,11}Δ}. Coefficients k_{2,n}, for n=1, . . . , 11 can assume different values belonging to a discrete and limited set of possible values according to the amplifier and combiner type. C₃ mapping coefficient can assume values from a set of amplitudes

$${C}_{3}^{( i )} ,$$

i=1, . . . , 8 belonging to a discrete alphabet A₃={0, a₂+k_{3,1}Δ−k_{3,2}a₁, a₂+k_{3,3}Δ+k_{3,4}a₁, a₂+k_{3,5}Δ, a₂+k_{3,6}Δ+k_{3,7}a₁}, with coefficients k_{3,n}, for n=1, . . . , 7, assuming different values belonging to a discrete and limited set of possible values according to the amplifier or combiner type. C₄ mapping coefficient can assume values from a set of amplitudes

$${C}_{4}^{( i )} ,$$

i=1, . . . , 16 belonging to a finite alphabet A₄={0, a₃+k_{4,1}Δ−k_{4,2}a₁, a₃+k_{4,3}Δ+k_{4,4}a₁, a₃+k_{4,5}Δ, a₃+k_{4,6}Δ+k_{4,7}a₁}. Coefficients k_{4,n}, with n=1, . . . , 7 can assume different values belonging to a discrete and limited set of possible values and are defined to enable an improved power relationship between components to improve the trade-off between power amplification and combination efficiency.

In another example, with the number of quantization bits N_{b} being four (4), N_{b′}=N_{b} and N′ being one (1) or two (2) active pairs of in-phase and quadrature-phase components, the punctured mapper circuitry 308 can be operable to select the mapping values of the corresponding mapping components based on the punctured mapping table such as given by:

Equivalent Mapping with Component Puncturing

| C₄ | C₃ | C₂ | C₁ |
|---|---|---|---|
| ${C}_{4}^{( 1 )}$ | ${C}_{3}^{( 1 )}$ | ${C}_{2}^{( 1 )}$ | ${C}_{1}^{( 1 )}$ |
| ${C}_{4}^{( 2 )}$ | ${C}_{3}^{( 2 )}$ | ${C}_{2}^{( 2 )}$ | ${C}_{1}^{( 2 )}$ |
| ${C}_{4}^{( 3 )}$ | ${C}_{3}^{( 3 )}$ | ${C}_{2}^{( 3 )}$ | ${C}_{1}^{( 3 )}$ |
| ${C}_{4}^{( 4 )}$ | ${C}_{3}^{( 4 )}$ | ${C}_{2}^{( 4 )}$ | ${C}_{1}^{( 4 )}$ |
| ${C}_{4}^{( 5 )}$ | ${C}_{3}^{( 5 )}$ | ${C}_{2}^{( 5 )}$ | ${C}_{1}^{( 5 )}$ |
| ${C}_{4}^{( 6 )}$ | ${C}_{3}^{( 6 )}$ | ${C}_{2}^{( 6 )}$ | X |
| ${C}_{4}^{( 7 )}$ | ${C}_{3}^{( 7 )}$ | ${C}_{2}^{( 7 )}$ | ${C}_{1}^{( 6 )}$ |
| ${C}_{4}^{( 8 )}$ | ${C}_{3}^{( 8 )}$ | ${C}_{2}^{( 8 )}$ | X |
| ${C}_{4}^{( 9 )}$ | ${C}_{3}^{( 9 )}$ | ${C}_{2}^{( 9 )}$ | ${C}_{1}^{( 7 )}$ |
| ${C}_{4}^{( 10 )}$ | ${C}_{3}^{( 10 )}$ | ${C}_{2}^{( 10 )}$ | X |
| ${C}_{4}^{( 11 )}$ | ${C}_{3}^{( 11 )}$ | X | ${C}_{1}^{( 8 )}$ |
| ${C}_{4}^{( 12 )}$ | ${C}_{3}^{( 12 )}$ | X | X |
| ${C}_{4}^{( 13 )}$ | ${C}_{3}^{( 13 )}$ | ${C}_{2}^{( 11 )}$ | ${C}_{1}^{( 9 )}$ |
| ${C}_{4}^{( 14 )}$ | ${C}_{3}^{( 14 )}$ | ${C}_{2}^{( 12 )}$ | X |
| ${C}_{4}^{( 15 )}$ | ${C}_{3}^{( 15 )}$ | X | ${C}_{1}^{( 10 )}$ |
| ${C}_{4}^{( 16 )}$ | ${C}_{3}^{( 16 )}$ | X | X |

In the table above, the coefficients Cₖ, k=1, . . . , N_{b}, needed to map the quantized value into a set of N_{b} pairs of in-phase s_{I,n} and quadrature-phase s_{Q,n} mapping components 209-{1ᵢ, . . . , 4ᵢ} and 209-{1_{q}, . . . , 4_{q}}, can be given by Cₖ cos(αₙ) and Cₖ sin(αₙ), where ‘X’ represents puncturing. C₁ mapping coefficient can assume values from a set of amplitudes

$${C}_{1}^{( i )} ,$$

i=1, . . . , 9 belonging to a discrete alphabet A₁={0, Δ, a₁+Δ, a₁+k_{1,1}Δ} where coefficient k_{1,1} is defined to enable an improved power relationship between components to improve the trade-off between power amplification and combination efficiency and assume different values belonging to a discrete and limited set of possible values. C₂ can assume values from a set of amplitudes

$${C}_{2}^{( i )} ,$$

i=1, . . . , 12, belonging to a discrete alphabet A₂={0, a₂+Δ, a₂+k_{2,2}Δ, a₂+k_{2,3}Δ+k_{2,4}a₁}. Coefficients k_{2,n}, for n=1, . . . , 4 can assume different values belonging to a discrete and limited set of possible values according to the amplifier or combiner type. C₃ mapping coefficient can assume values from a set of amplitudes

$${C}_{3}^{( i )} ,$$

i=1, . . . , 8 belonging to a discrete alphabet A₃={0, a₃+Δ, a₃+Δ+a₁, a₃+k_{3,1}Δ, a₂+k_{3,2}Δ+k_{3,3}a₁, a₃+k_{3,4}Δ, a₃+k_{3,5}Δ+k_{3,6}a₁, a₃+k_{3,7}Δ+k₃, a₂, a₃+k_{3,9}Δ+k_{3,10}a₁Δ+k_{3,11}a₂}, with coefficients k_{3,n}, for n=1, . . . , 11, assuming different values belonging to a discrete and limited set of possible values according to the amplifier or combiner type. C₄ mapping coefficient can assume values from a set of amplitudes

$${C}_{4}^{( i )} ,$$

i=1, . . . , 16 belonging to a finite alphabet A₄={0, a₄+Δ, a₄+Δ+a₁, a₄+Δ+a₂a₄+Δ+a₂+aᵢ, a₄+k_{4,1}Δ, a₄+k_{4,2}Δ+k_{4,3}a₁, a₄+k_{4,4}Δ+k₄, a₂, a₄+k_{4,6}Δ+k_{4,7} a₁+k_{4,8}a₂}. Coefficients k_{4,n}, with n=1, . . . , 8 can assume different values belonging to a discrete and limited set of possible values and can be defined to enable an improved power relationship between components to improve the trade-off between power amplification and combination efficiency.

In another example, the punctured encoding table can be represented by:

Equivalent Bit Coding with Bit Puncturing

| Bit 4 | Bit 3 | Bit 2 | Bit 1 |
|---|---|---|---|
| 0 | 0 | 0 | 0 |
| 0 | 0 | 0 | 1 |
| 0 | 0 | 1 | 0 |
| 0 | 0 | 1 | 1 |
| 0 | 1 | 0 | 0 |
| 0 | 1 | 0 | X |
| 0 | 1 | 1 | 0 |
| 0 | 1 | 1 | X |
| 1 | 0 | 0 | 0 |
| 1 | 0 | 0 | X |
| 1 | 0 | X | 0 |
| 1 | 0 | X | X |
| 1 | 1 | 0 | 0 |
| 1 | 1 | 0 | X |
| 1 | 1 | X | 0 |
| 1 | 1 | X | X |

where ‘X’ denotes a punctured bit.

In another example, the punctured encoding table and the equivalent mapping with component puncturing can be represented by the table below and can enable a system to have two (2) DAC circuitry and a set of four (4) power amplifier circuitry.

| Equivalent Bit Coding with | | | | | | | |
|---|---|---|---|---|---|---|---|
| Bit Puncturing | | | | Equivalent Mapping with Component Puncturing | | | |
| Bit 4 | Bit 3 | Bit 2 | Bit 1 | C₄ | C₃ | C₂ | C₁ |
| 0 | 0 | 0 | 0 | 0 | 0 | 0 | A |
| 0 | 0 | 0 | 1 | 0 | 0 | 0 | a₁ + Δ |
| 0 | 0 | 1 | 0 | 0 | 0 | a₂ + Δ | 0 |
| 0 | 0 | 1 | 1 | 0 | 0 | ${a}_{2} + \frac{{a}_{2}}{{a}_{2} + {a}_{1}} Δ$ | ${a}_{1} + \frac{{a}_{1}}{{a}_{2} + {a}_{1}} Δ$ |
| 0 | 1 | 0 | 0 | 0 | a₃ + Δ | 0 | 0 |
| 0 | 1 | 0 | X | 0 | a₃ + Δ + a₁ | 0 | X |
| 0 | 1 | 1 | 0 | 0 | ${a}_{3} + \frac{{a}_{3}}{{a}_{3} + {a}_{2}} Δ$ | ${a}_{2} + \frac{{a}_{2}}{{a}_{3} + {a}_{2}} Δ$ | 0 |
| 0 | 1 | 1 | X | 0 | ${a}_{3} + \frac{{a}_{3}}{{a}_{3} + {a}_{2}} ( Δ + {a}_{1} )$ | ${a}_{4} + \frac{{a}_{4}}{{a}_{4} + {a}_{3}} Δ$ | X |
| 1 | 0 | 0 | 0 | a₄ + Δ | 0 | 0 | 0 |
| 1 | 0 | 0 | X | a₄ + Δ + a₁ | 0 | 0 | X |
| 1 | 0 | X | 0 | a₄ + Δ + a₂ | 0 | X | 0 |
| 1 | 0 | X | X | a₄ + Δ + a₂ + a₁ | 0 | X | X |
| 1 | 1 | 0 | 0 | ${a}_{4} + \frac{{a}_{4}}{{a}_{4} + {a}_{3}} Δ$ | ${a}_{3} + \frac{{a}_{3}}{{a}_{4} + {a}_{3}} Δ$ | 0 | 0 |
| 1 | 1 | 0 | X | ${a}_{4} + \frac{{a}_{4}}{{a}_{4} + {a}_{3}} ( Δ + {a}_{1} )$ | ${a}_{3} + \frac{{a}_{3}}{{a}_{4} + {a}_{3}} ( Δ + {a}_{1} )$ | 0 | X |
| 1 | 1 | X | 0 | ${a}_{4} + \frac{{a}_{4}}{{a}_{4} + {a}_{3}} ( Δ + {a}_{2} )$ | ${a}_{3} + \frac{{a}_{3}}{{a}_{4} + {a}_{3}} ( Δ + {a}_{2} )$ | X | 0 |
| 1 | 1 | X | X | ${a}_{4} + \frac{{a}_{4}}{{a}_{4} + {a}_{3}} ( Δ + {a}_{1} + {a}_{2} )$ | ${a}_{3} + \frac{{a}_{3}}{{a}_{4} + {a}_{3}} ( Δ + {a}_{1} + {a}_{2} )$ | X | X |

In the table above, C₁ component amplitudes can belong to a finite alphabet with possible values of

$$\{ 0 , Δ , {a}_{1} + Δ , {a}_{1} + \frac{{a}_{1}}{{a}_{2} + {a}_{1}} Δ \} . {C}_{2}$$

component amplitudes can belong to a finite alphabet with possible values of

$$\{ 0 , {a}_{2} + Δ , {a}_{2} + \frac{{a}_{2}}{{a}_{2} + {a}_{1}} Δ , {a}_{2} + \frac{{a}_{2}}{{a}_{3} + {a}_{2}} Δ , {a}_{2} + \frac{{a}_{2}}{{a}_{3} + {a}_{2}} ( Δ + {a}_{1} ) \} . {C}_{3}$$

component amplitudes can belong to a finite alphabet with possible values of

$$\{ 0 , {a}_{3} + Δ , {a}_{3} + Δ + {a}_{1} , {a}_{3} + \frac{{a}_{3}}{{a}_{4} + {a}_{3}} Δ , {a}_{3} + \frac{{a}_{3}}{{a}_{4} + {a}_{3}} ( Δ + {a}_{1} ) , {a}_{3} + \frac{{a}_{3}}{{a}_{4} + {a}_{3}} Δ , {a}_{3} + \frac{{a}_{3}}{{a}_{4} + {a}_{3}} ( Δ + {a}_{1} ) , {a}_{3} + \frac{{a}_{3}}{{a}_{4} + {a}_{3}} ( Δ + {a}_{2} ) , {a}_{3} + \frac{{a}_{3}}{{a}_{4} + {a}_{3}} ( Δ + {a}_{1} + {a}_{2} ) \} ,$$

where Δ is a discrete correction factor with values belonging to a discrete and finite alphabet. C₄ component amplitudes belong to a finite alphabet with possible values of

$$\{ 0 , {a}_{4} + Δ , {a}_{4} + Δ + {a}_{1} , {a}_{4} + Δ + {a}_{2} , {a}_{4} + Δ + {a}_{2} + {a}_{1} , {a}_{4} + \frac{{a}_{4}}{{a}_{4} + {a}_{3}} Δ , {a}_{4} + \frac{{a}_{4}}{{a}_{4} + {a}_{3}} ( Δ + {a}_{1} ) , {a}_{4} + \frac{{a}_{4}}{{a}_{4} + {a}_{3}} ( Δ + {a}_{2} ) , {a}_{4} + \frac{{a}_{4}}{{a}_{4} + {a}_{3}} ( Δ + {a}_{1} + {a}_{2} ) \} .$$

Amplitudes a₁, a₂, a₃ and a₄ can be defined to enable an improved power relationship between components in order to increase the combination efficiency at the combiner circuitry and can assume different values belonging to a discrete and limited set of possible values for each combiner type.

In FIG. 3, the punctured mapper circuitry 308 can be operable to provide an active set of N′≤N_{b}+1 pairs of in-phase and quadrature-phase mapping components 309-{1ᵢ, . . . , 4ᵢ} and 309-{1_{q}, . . . , 4_{q}}, to a set of N′ bandpass modulator circuitry 310-{1, . . . , 4}(e.g., I/Q DACs, I/Q modulators) operable to generate a punctured set of bandpass components 311-{1, . . . , 4}.

In another embodiment, without a set of mixer circuitry 312-{1, . . . , 4}, the set of bandpass modulator circuitry 310-{1, . . . , 4} can be operable to generate a punctured set of bandpass components 311-{1, . . . , 4} having the carrier frequency f_{c}, with the punctured set of signals 311-{1, . . . , 4} having the same carrier frequency as signals 313-{1, . . . , 4}.

In another embodiment, the punctured mapper circuitry 308 can also be operable to generate control information to activate or deactivate any of the set of mixer circuitry 312-{1, . . . , 4} to control the active set of power amplifier circuitry 314-{1, . . . , 4} that correspond to the active set of mapping components 309-{1ᵢ, . . . , 4ᵢ} and 309-{1_{q}, . . . , 4_{q}} and to control the combiner circuitry 316.

In another embodiment, the punctured mapper circuitry 308 can be operable to control the initial phase of the punctured set of bandpass signals 311-{1, . . . , 4} generated by the set of bandpass modulator circuitry 310-{1, . . . , 4}, based on the phase αₙ of each sample.

In another embodiment, the set of bandpass modulators 310-{1, . . . , 4} can be operable to generate a punctured set of bandpass components 311-{1, . . . , 4} at an intermediate frequency fᵢ and the set of mixer circuitry 312-{1, . . . , 4} can be operable to up-convert the punctured set of bandpass components 311-{1, . . . , 4} to the carrier frequency f_{c} to obtain the punctured set of bandpass components 313-{1, . . . , 4}.

In FIG. 3, the active set of power amplifiers 314-{1, . . . , 4} can be operable to amplify the punctured set of bandpass signals 313-{1, . . . , 4}. The punctured set of amplified signals 315-{1, . . . , 4} where only N′ are active, correspond to the amplified signals of the punctured set of bandpass components 313-{1, . . . , 4}. The combiner circuitry 316 can be operable to combine the punctured set of amplified signals 315-{1, . . . , 4} to obtain an output signal 317.

In another embodiment, the punctured mapper circuitry 308 can be operable to generate control information 309-pac to activate or deactivate each of the set of power amplifier circuitry 314-{1, . . . , 4} and to generate control information 309-cc to control the combiner circuitry 316 of block B2.

In another embodiment, the combiner circuitry 316 can be configured to be resistive, hybrid, Wilkinson, transformer based, based on voltage or current combining after transform matching, an impedance matching network, or the like.

In FIG. 3, an oscillator circuitry 301s-2 can be configured to receive an input signal having a reference frequency associated with a carrier frequency f_{c}, an intermediate frequency fᵢ, a frequency associated with up conversion from the intermediate frequency fᵢ to the carrier frequency f_{c}, or the like. When signal 301s-1 is an intermediate frequency fᵢ, the oscillator circuitry 301s-2 can be operable to generate a reference sinusoidal signal 301s-3 for input to the set of mixer circuitry 312-{1, . . . , 4} operable to up-convert the punctured set of bandpass signals 311-{1, . . . , 4} of an intermediate frequency fᵢ to obtain the punctured set of bandpass signals 313-{1, . . . , 4}.

In another embodiment, the punctured mapper circuitry 308 can be operable to receive, from the set of bandpass modulator circuitry 310-{1, . . . , 4}, feedback signals F-{1, . . . , 4} to generate time or phase control information for the set of bandpass modulator circuitry 310-{1, . . . , 4} to enable time or phase synchronization of the punctured set of bandpass components 311-{1, . . . , 4}.

In another embodiment, the punctured mapper circuitry 308 can be operable to receive, from the set of mixer circuitry 312-{1, . . . , 4}, feedback signals F-{1, . . . , 4} to generate time or phase control information to enable time or phase synchronization of the punctured set of bandpass components 313-{1, . . . , 4}.

In another embodiment, the punctured mapper circuitry 308 can be operable to receive, from the set of power amplifier circuitry 314-{1, . . . , 4}, feedback signals Fa-{1, . . . , 4} to generate time or phase control information to enable time or phase synchronization of the punctured set of amplified signals 315-{1, . . . , 4}.

In another embodiment, the system 300 can be configured to receive the reference clock signal 301s-1 having an intermediate frequency fᵢ for input to the set of bandpass modulator circuitry 310-{1, . . . , 4}. Further, the system 300 can be configured to receive the clock signal 301-f_{c} having the carrier frequency f_{c} for input to the set of mixer circuitry 312-{1, . . . , 4} operable to up-convert the punctured set of bandpass components 311-{1, . . . , 4} to obtain the punctured set of bandpass components 313-{1, . . . , 4}.

In another embodiment, circuitry B1 can be configured to include the sampling circuitry 321, the punctured mapper circuitry 308, the quantizer encoder circuitry 303, or the like. Further, the circuitry B1 can be implemented in a single circuitry block with hardware, software or firmware, including digital or analog techniques, and with or without microprocessors, FPGAs or DSPs.

In another embodiment, the combiner circuitry 316 can be operable to output, to the punctured mapper circuitry 308, feedback signal F to control information generation.

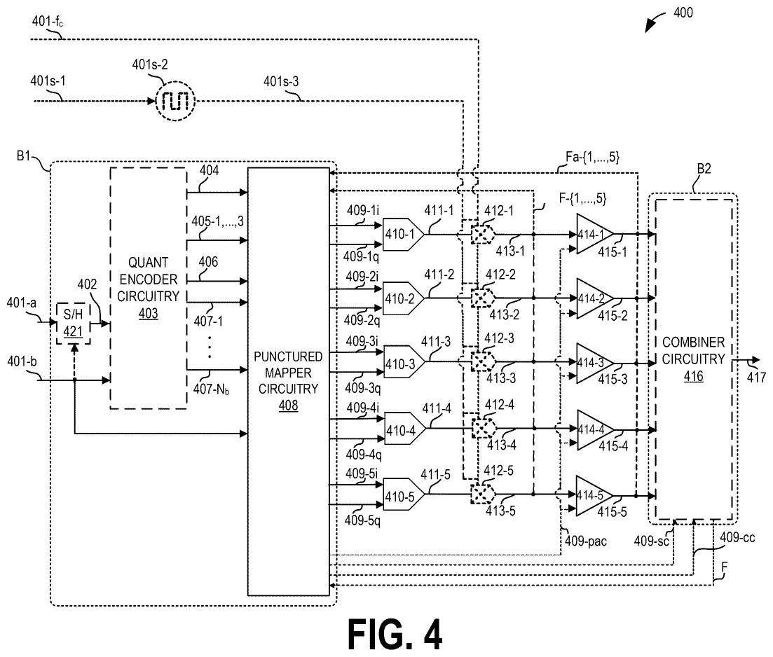

FIG. 4 illustrates another embodiment of a system 400 of quantized punctured bandpass component generation for power combination in accordance with various aspects as described herein. As illustrated in FIG. 4, the number of quantization bits N_{b} is four (4) and N_{b′}=N_{b}+1 active bandpass components, where N_{b′}≤2. In FIG. 4, the system 400 can be configured to receive an input signal 401-a having time samples sₙ of a baseband signal. In one example, the input signal 401-a can include the samples s_{In} and s_{Qn} of the in-phase and quadrature-phase components of a baseband signal. In another example, the input signal 401-a can be a baseband signal s(t), which is sampled by a sampling circuitry or a sample and hold circuitry 421 operable to generate the time samples sₙ=s(tₙ). The system 400 can also be configured to receive a clock reference signal 401-b having a sampling frequency fₛ. In one example, the system 400 can be configured to receive a reference clock signal 401s-1 having an intermediate frequency fᵢ, a reference clock signal 401s-fc having a carrier frequency f_{c}, or the like. A skilled artisan will recognize that the selection of the clock reference signals can be made according to the bandwidth of an input signal, the desired frequency of an output signal, the frequency for up-converting bandpass components, or the like. The system 400 can be configured to receive clock signal 401-b having a sampling frequency for input to the sampling circuitry or the sample and hold circuitry 421, a quantization encoding circuitry 403, the punctured mapper 408, a set of bandpass modulator circuitry 410-{1, . . . , 5}, or the like.

In FIG. 4, the quantizer encoder circuitry 403 can be operable to receive each sample sₙ of the input signal s(t), and compute the amplitude Aₙ and the phase αₙ of that sample sₙ. Further, the quantizer encoder circuitry 403 can be configured to include a quantization encoding table having N_{b} quantization bits for each quantized amplitude value, a table having a finite set of quantization values, a table having the sets of discrete amplitudes of the quantization components aᵢ={a₁, a₂, . . . , a_{N}_{_{b+1}}} in which the quantized value can be decomposed, the set of quantized values, or the like. The quantizer encoder circuitry 403 can be operable to quantize the amplitude Aₙ of each sample, generate the quantized amplitude A_{qn}=Aₙ+e_{q} and the set of quantization bits 407-{1, . . . , N_{b}}, compute a compensation factor Δ belonging to a finite discrete alphabet based on the quantization error e_{q}=Aₙ−A_{qn}, or the like. The quantizer encoder circuitry 403 can also be operable to generate a punctured encoding table and output, to the punctured mapper circuitry 408, signal 404 that represents the punctured encoding table. The quantizer encoder circuitry 403 can also be operable to output, to the punctured mapper circuitry 408, the set of quantization bits 407-{1, . . . , N_{b}} that represents the quantized amplitude A_{qn}, a signal 405-{1, . . . , 3} that represents the amplitude Aₙ, the phase αₙ and the compensation factor Δ, a signal 406 that represents the discrete amplitudes of the quantization components aᵢ, or the like. The punctured mapper circuitry 408 can be operable to generate a set of N′≤N_{b}+1 active pairs of in-phase and quadrature-phase mapping components based on a punctured mapping table that can be stored in a LUT circuitry configured to include the mapping components values according to a puncturing rule, the quantization bit combinations, the sets of discrete amplitudes aᵢ, the set of quantized values, or the like.

In the current embodiment, the punctured mapper circuitry 408 can be configured to include the quantization bits and the punctured encoding table 406 and can be operable to select the mapping values of the corresponding mapping components on a punctured mapping table such as given by:

Equivalent Mapping with Component Puncturing

| C₅ | C₄ | C₃ | C₂ | C₁ |
|---|---|---|---|---|
| ${C}_{5}^{( 1 )}$ | ${C}_{4}^{( 1 )}$ | ${C}_{3}^{( 1 )}$ | ${C}_{2}^{( 1 )}$ | ${C}_{1}^{( 1 )}$ |
| ${C}_{5}^{( 2 )}$ | ${C}_{4}^{( 2 )}$ | ${C}_{3}^{( 2 )}$ | ${C}_{2}^{( 2 )}$ | ${C}_{1}^{( 2 )}$ |
| ${C}_{5}^{( 3 )}$ | ${C}_{4}^{( 3 )}$ | ${C}_{3}^{( 3 )}$ | ${C}_{2}^{( 3 )}$ | ${C}_{1}^{( 3 )}$ |
| ${C}_{5}^{( 4 )}$ | ${C}_{4}^{( 4 )}$ | ${C}_{3}^{( 4 )}$ | ${C}_{2}^{( 4 )}$ | X |
| ${C}_{5}^{( 5 )}$ | ${C}_{4}^{( 5 )}$ | ${C}_{3}^{( 5 )}$ | ${C}_{2}^{( 5 )}$ | ${C}_{1}^{( 4 )}$ |
| ${C}_{5}^{( 6 )}$ | ${C}_{3}^{( 2 )}$ | ${C}_{3}^{( 6 )}$ | X | X |
| ${C}_{5}^{( 7 )}$ | ${C}_{4}^{( 7 )}$ | ${C}_{3}^{( 7 )}$ | ${C}_{2}^{( 6 )}$ | ${C}_{1}^{( 5 )}$ |
| ${C}_{5}^{( 8 )}$ | ${C}_{4}^{( 8 )}$ | ${C}_{3}^{( 8 )}$ | X | X |
| ${C}_{5}^{( 9 )}$ | ${C}_{4}^{( 9 )}$ | ${C}_{3}^{( 9 )}$ | ${C}_{2}^{( 7 )}$ | ${C}_{1}^{( 6 )}$ |
| ${C}_{5}^{( 10 )}$ | ${C}_{4}^{( 10 )}$ | ${C}_{3}^{( 10 )}$ | X | X |
| ${C}_{5}^{( 11 )}$ | ${C}_{4}^{( 11 )}$ | X | ${C}_{2}^{( 8 )}$ | ${C}_{1}^{( 7 )}$ |
| ${C}_{5}^{( 12 )}$ | ${C}_{4}^{( 12 )}$ | X | X | X |
| ${C}_{5}^{( 13 )}$ | ${C}_{4}^{( 13 )}$ | ${C}_{3}^{( 11 )}$ | ${C}_{2}^{( 9 )}$ | ${C}_{1}^{( 8 )}$ |
| ${C}_{5}^{( 14 )}$ | ${C}_{4}^{( 14 )}$ | ${C}_{3}^{( 12 )}$ | X | X |
| ${C}_{5}^{( 15 )}$ | ${C}_{4}^{( 15 )}$ | X | ${C}_{2}^{( 10 )}$ | ${C}_{1}^{( 9 )}$ |
| ${C}_{5}^{( 16 )}$ | ${C}_{4}^{( 16 )}$ | X | X | X |

The coefficients Cₖ, k=1, . . . , N_{b}+1, needed to map the quantized value into N′≤N_{b} pairs of in-phase s_{I,n} and quadrature-phase s_{Q,n} mapping components 409-{1ᵢ, . . . , 5ᵢ} and 409-{1_{q}, . . . , 5_{q}}, can be given by Cₖ cos(αₙ) and Cₖ sin(αₙ). C₁ mapping coefficient can assume values from a set of amplitudes

$${C}_{1}^{( i )} ,$$

i=1, . . . , 9, belonging to a discrete alphabet A₁={0, k_{1,1}Δ, k_{1,2}a₁+k_{1,3}Δ}, where Δ is the discrete compensation factor with values belonging to a discrete and finite alphabet. Coefficients k_{1,n}, with n=1, . . . , 3, can assume different values belonging to a discrete and limited set of possible values according to the amplifier or combiner type as in previous embodiments. C₂ mapping coefficients can assume values from a set of amplitudes

$${C}_{2}^{( i )} ,$$

i=1, . . . , 10 belonging to a discrete alphabet A₂={0, k_{2,1}Δ, k_{2,2}a₁+k_{2,3}Δ, k_{2,4}a₁+k_{2,5}Δ}. Coefficients k_{2,n}, with n=1, . . . , 5, can assume different values belonging to a discrete and limited set of possible values according to the amplifier or combiner type as in previous embodiments. C₃ mapping coefficient can assume values from a set of amplitudes

$${C}_{3}^{( i )} ,$$

i=1, . . . , 12 belonging to a discrete alphabet A₃={0, a₂+Δ, a₂+k_{3,1}Δ+k_{3,2}a₁, a₂+k_{3,3}Δ, a₂+k_{3,4}Δ+k_{3,5}a₁}, with coefficients k_{3,n}, with n=1, . . . , 5, can assume different values belonging to a discrete and limited set of possible values and can be defined to enable an improved power relationship between components to improve the trade-off between power amplification and combination efficiency. C₄ mapping coefficient can assume values from a set of amplitudes

$${C}_{4}^{( i )} ,$$

i=1, . . . , 16, belonging to a finite alphabet A₄={0, a₃+Δ, a₃+Δ+k_{4,1}a₁, a₃+k_{4,2}Δ, a₃+k_{4,3}Δ+k_{4,4}a₁, a₃+k_{4,5}Δ, a₃+k_{4,6}Δ+k_{4,7}a₁, a₃+k_{4,8}+k_{4,9}a₂, a₃+k_{4,10}Δ+k_{4,11}a₁+k_{4,12}a₂}, where Δ is the discrete compensation factor with values belonging to a discrete and finite alphabet. Coefficients k_{4,n}, with n=1, . . . , 12, can assume different values belonging to a discrete and limited set of possible values and can be defined to enable an improved power relationship between components to improve the trade-off between power amplification and combination efficiency. C₅ mapping coefficient can assume values from a set of amplitudes

$${C}_{5}^{( i )} ,$$

i=1, . . . , 16 belonging to a finite alphabet A₅={0, a₄+Δ, a₄+Δ+k_{5,1}a₁, a₄+Δ+a₂, a₄+k_{5,3}Δ, a₄+k_{5,4}Δ+k_{5,5}a₁, a₄+k_{5,6}Δ, +k_{5,7}a₂, a₄+k_{5,8}Δ+k_{5,9}a₁+k_{5,10}a₂}. Coefficients k_{5,n} with n=1, . . . , 10, can assume different values belonging to a discrete and limited set of possible values according to the amplifier or combiner type.

In another example, with the number of quantization bits N_{b} being four (4), N_{b′}=N_{b}+1 being two (2) active pairs of in-phase and quadrature-phase components, the punctured mapper circuitry 408 can be operable to select the mapping values of the corresponding mapping components based on the punctured mapping table such as represented by:

Equivalent Mapping with Component Puncturing

| C₅ | C₄ | C₃ | C₂ | C₁ |
|---|---|---|---|---|
| ${C}_{5}^{( 1 )}$ | ${C}_{4}^{( 1 )}$ | ${C}_{3}^{( 1 )}$ | ${C}_{2}^{( 1 )}$ | ${C}_{1}^{( 1 )}$ |
| ${C}_{5}^{( 2 )}$ | ${C}_{4}^{( 2 )}$ | ${C}_{3}^{( 2 )}$ | ${C}_{2}^{( 2 )}$ | ${C}_{1}^{( 2 )}$ |
| ${C}_{5}^{( 3 )}$ | ${C}_{4}^{( 3 )}$ | ${C}_{3}^{( 3 )}$ | ${C}_{2}^{( 3 )}$ | ${C}_{1}^{( 3 )}$ |
| ${C}_{5}^{( 4 )}$ | ${C}_{4}^{( 4 )}$ | ${C}_{3}^{( 4 )}$ | ${C}_{2}^{( 4 )}$ | X |
| ${C}_{5}^{( 5 )}$ | ${C}_{4}^{( 5 )}$ | ${C}_{3}^{( 5 )}$ | ${C}_{2}^{( 5 )}$ | ${C}_{1}^{( 4 )}$ |
| ${C}_{5}^{( 6 )}$ | ${C}_{4}^{( 6 )}$ | ${C}_{3}^{( 6 )}$ | ${C}_{2}^{( 6 )}$ | X |
| ${C}_{5}^{( 7 )}$ | ${C}_{4}^{( 7 )}$ | ${C}_{3}^{( 7 )}$ | ${C}_{2}^{( 7 )}$ | ${C}_{1}^{( 5 )}$ |
| ${C}_{5}^{( 8 )}$ | ${C}_{4}^{( 8 )}$ | ${C}_{3}^{( 8 )}$ | X | X |
| ${C}_{5}^{( 9 )}$ | ${C}_{4}^{( 9 )}$ | ${C}_{3}^{( 9 )}$ | ${C}_{2}^{( 8 )}$ | ${C}_{1}^{( 6 )}$ |
| ${C}_{5}^{( 10 )}$ | ${C}_{4}^{( 10 )}$ | ${C}_{3}^{( 10 )}$ | ${C}_{2}^{( 9 )}$ | X |
| ${C}_{5}^{( 11 )}$ | ${C}_{4}^{( 11 )}$ | ${C}_{3}^{( 11 )}$ | ${C}_{2}^{( 10 )}$ | ${C}_{1}^{( 7 )}$ |
| ${C}_{5}^{( 12 )}$ | ${C}_{4}^{( 12 )}$ | ${C}_{3}^{( 12 )}$ | X | X |
| ${C}_{5}^{( 13 )}$ | ${C}_{4}^{( 13 )}$ | ${C}_{3}^{( 13 )}$ | ${C}_{2}^{( 11 )}$ | ${C}_{1}^{( 8 )}$ |
| ${C}_{5}^{( 14 )}$ | ${C}_{4}^{( 14 )}$ | ${C}_{3}^{( 14 )}$ | X | X |
| ${C}_{5}^{( 15 )}$ | ${C}_{4}^{( 15 )}$ | X | ${C}_{2}^{( 12 )}$ | ${C}_{1}^{( 9 )}$ |
| ${C}_{5}^{( 16 )}$ | ${C}_{4}^{( 16 )}$ | X | X | X |

In the table above, the coefficients Cₖ, k=1, . . . , N_{b}+1, in which C₁ mapping coefficient can assume values from a set of amplitudes

$${C}_{1}^{( i )} ,$$

i=1, . . . , 9, belonging to a discrete alphabet A₁={0, k_{1,1}Δ, k_{1,2}a₁+k_{1,3}Δ}, where Δ is the discrete compensation factor having values belonging to a discrete and finite alphabet. Coefficients k_{1,n}, with n=1, . . . , 3, can assume different values belonging to a discrete and limited set of possible values according to the amplifier or combiner type as in previous embodiments. C₂ mapping coefficient can assume values from a set of amplitudes

$${C}_{2}^{( i )} ,$$

i=1, . . . , 12 belonging to a discrete alphabet A₂={0, k_{2,1}Δ, k_{2,2}a₁+k_{2,3}Δ, a₁+k_{2,4}Δ, a₁+k_{2,5}Δ, a₁+k_{2,6}Δ, a₁+k_{2,7}Δ, a₁+k_{2,8}Δ, a₁+k_{2,9}Δ}. Coefficients k_{2,n} with n=1, . . . , 9, can assume different values belonging to a discrete and limited set of possible values according to the amplifier or combiner type as in previous embodiments. C₃ mapping coefficient can assume values from a set of amplitudes

$${C}_{3}^{( i )} ,$$

i=1, . . . , 14 belonging to a discrete alphabet A₃={0, a₂+k_{3,1}Δ−a₁, a₂+k_{3,2}Δ+a₁, a₂+k_{3,3}Δ, a₂+k₃,4Δ+k_{3,5} a₁, a₂+k_{3,6}Δ, a₂+k_{3,7}Δ+k_{3,8}a₁}, with coefficients k_{3,n}, with n=1, . . . , 8, can assume different values belonging to a discrete and limited set of possible values according to the amplifier or combiner type as in previous embodiments. C₄ mapping coefficient can assume values from a set of amplitudes

$${C}_{4}^{( i )} ,$$

i=1, . . . , 16, belonging to a finite alphabet A₄={0, a₃+k_{4,1}Δ−a₁, a₃+k_{4,2}Δ+a₁, a₃+k_{4,3}Δ, a₃+k_{4,4}Δ+k_{4,5} a₁, a₃+k_{4,6}Δ, a₃+k_{4,7}Δ+k_{4,8} a₁, a₃+k_{4,9}Δ+k_{4,10} a₂, a₃+k_{4,11}Δ+k_{4,12}a₂+k_{4,13}a₁}, where Δ is the discrete compensation factor with values belonging to a discrete and finite alphabet. Coefficients k_{4,n}, with n=1, . . . , 13, can assume different values belonging to a discrete and limited set of possible values according to the amplifier or combiner type as in previous embodiments. C₅ mapping coefficient can assume values from a set of amplitudes

$${C}_{5}^{( i )} ,$$

i=1, . . . , 16 belonging to a finite alphabet A₅={0, a₄+k_{5,1}Δ−a₁, a₄+k_{5,2}Δ+a₁, a₄+k_{5,3}Δ, a₄+k_{5,4}Δ+k_{5,5}a₁, a₃+k_{5,6}Δ, a₄+k_{5,7}Δ+k_{5,8}a₁, a₄+k_{5,9}Δ+k_{5,10}a₂, a₄+k_{5,11}Δ+k_{5,12}a₂+k_{5,13}a₁}. Coefficients k_{5,n} with n=1, . . . , 13, can assume different values belonging to a discrete and limited set of possible values according to the amplifier or combiner type.

In FIG. 4, the punctured mapper circuitry 408 can be operable to provide an active set of N′≤N_{b}+1 pairs of in-phase and quadrature-phase mapping components 409-{1ᵢ, . . . , 5ᵢ} and 409-{1_{q}, . . . , 5_{q}}, to an active set of N′ bandpass modulator circuitry 410-{1, . . . , 5 (e.g., I/Q DACs, I/Q modulators) operable to generate the punctured set of bandpass components 411-{1, . . . , 5}. In one example, without the set of mixer circuitry 412-{1, . . . , 5}, the set of N′ bandpass modulator circuitry 410-{1, . . . , 5} can be operable to generate the punctured set of bandpass components 411-{1, . . . , 5} having a carrier frequency f_{c}, and corresponding to the signals 413-{1, . . . , 5}. Punctured mapper circuitry 408 can also be operable to generate control information to active or deactivate the set of mixer circuitry 412-{1, . . . , N′}, control the set of power amplifier circuitry 414-{1, . . . , 5} that corresponds to the active set of mapping components 409-{1ᵢ, . . . , 5ᵢ} and 409-{1_{q}, . . . , 5_{q}} and the punctured set of bandpass components 413-{1, . . . , N′}, control the combiner circuitry 416, or the like.

In another embodiment, the punctured mapper circuitry 408 can be operable to control, based on the phase αₙ of each sample, the initial phase of the punctured set of bandpass signals generated by the set of bandpass modulator circuitry.

In another embodiment, the set of bandpass modulator circuitry 410-{1, . . . , 5} can be operable to generate the punctured set of bandpass components 411-{1, . . . , 5} at the intermediate frequency fᵢ and the set of mixer circuitry 412-{1, . . . , 5} can be operable to up-convert the punctured set of bandpass components 411-{1, . . . , 5} to the carrier frequency f_{c} to obtain the punctured set of bandpass components 413-{1, . . . , 5}.

In FIG. 4, the set of power amplifier circuitry 414-{1, . . . , 5} can be operable to amplify the punctured set of bandpass signals 413-{1, . . . , 5}. The punctured set of amplified signals 415-{1, . . . , 5}, where only N′ are active, can correspond to the punctured set of bandpass components 411-{1, . . . , 5}, 413-{1, . . . , 5}. The combiner circuitry 416 can be operable to combine the punctured set of amplified signals 415-{1, . . . , 5} to generate the output signal 417.

In another embodiment, the punctured mapper 409 can be operable to generate control information 409-pac to activate or deactivate the set of power amplifier circuitry 414-{1, . . . , 5}, control information 409-cc to activate or deactivate combining elements of the combiner circuitry 416 of circuitry block B2.

In another embodiment, the combiner circuitry 416 can be configured as a resistive, hybrid, Wilkinson, transformer based, based on voltage or current combining after transform matching, an impedance matching network, or the like.

In FIG. 4, the oscillator circuitry 401s-2 can be configured to receive signal 401s-1 associated with a reference frequency. For example, the signal 401s-1 can include a reference frequency of a carrier frequency f_{c}, an intermediate frequency fᵢ, a frequency associated with up-conversion from an intermediate frequency fᵢ to a carrier frequency f_{c}, or the like. When the signal 401s-1 includes an intermediate frequency fᵢ, the oscillator circuitry 401s-2 can be operable to generate a reference sinusoidal signal 301s-3 that can be input to the set of mixer circuitry 412-{1, . . . , 5} to up-convert the punctured set of bandpass signals 411-{1, . . . , 5} to the carrier frequency f_{c} to obtain the punctured set of bandpass signals 413-{1, . . . , 5}.

In another embodiment, the punctured mapper circuitry 408 can be configured to receive, from the set of bandpass modulator circuitry 410-{1, . . . , N_{b}+1}, feedback signals F-{1, . . . , N_{b}+1} to generate time or phase control information for the set of bandpass modulators 410-{1, . . . , N_{b}+1} to enable time or phase synchronization of the punctured set of bandpass components 411-{1, . . . , 5}.

In another embodiment, the punctured mapper circuitry 408 can be operable to receive, from the set of mixer circuitry 412-{1, . . . , N_{b}+1}, feedback signals F-{1, . . . , N_{b}+1} to generate time or phase control information to enable time or phase synchronization of the punctured set of bandpass components 413-{1, . . . , 5}.

In another embodiment, the punctured mapper circuitry 408 can be operable to receive, from the set of amplifier circuitry 414-{1, . . . , N_{b}+1}, feedback signals Fa-{1, . . . , N_{b}+1}.

In another embodiment, the punctured mapper circuitry 408 can be operable to receive, from the outputs of the active set of power amplifier circuitry 415-{1, . . . , N_{b}+1}, feedback signals Fa-{1, . . . , N_{b}+1} to generates time or phase control information for the active set of bandpass modulator circuitry 410-{1, . . . , N′}(e.g., I/Q modulators, I/Q DACs) to enable time or phase synchronization of the punctured set of bandpass components 415-{1, . . . , Nb+1}.

In another embodiment, the system 400 can be configured to receive the reference clock signal 401s-1 having the intermediate frequency fᵢ for input to the set of bandpass modulator circuitry 410-{1, . . . , N_{b}+1}. Further, the system 400 can be configured to receive the input signal 401-f_{c} having the carrier frequency f_{c} for input to the set of mixer circuitry 412-{1, . . . , Nb+1} to enable up-conversion of the punctured set of bandpass components 411-{1, . . . , N_{b}+1}.

In another embodiment, the punctured mapper circuitry 408 can be operable to receive, from the combiner circuitry 416, feedback signal F to enable generation of control information.

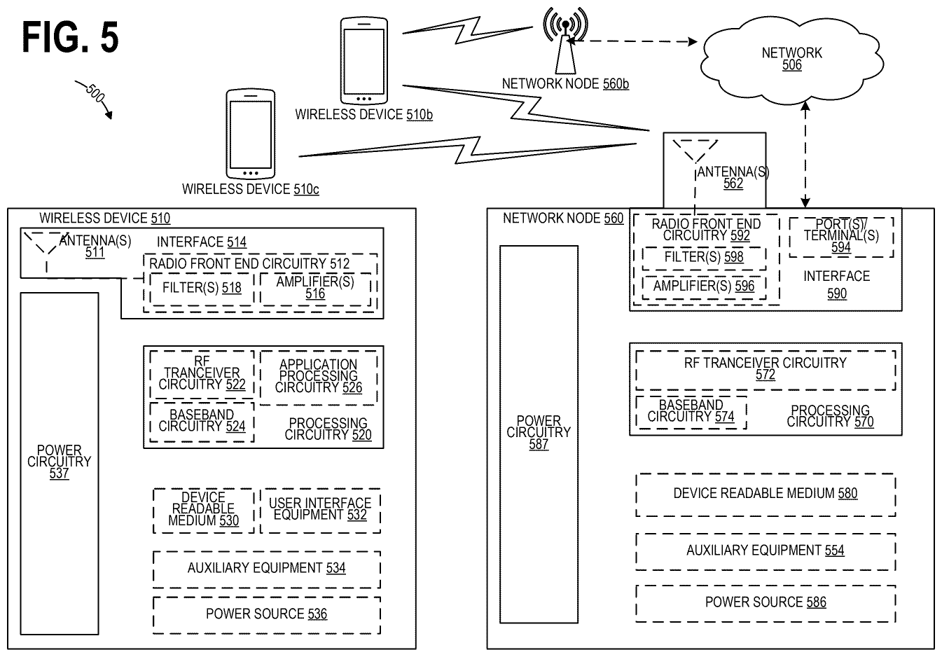

Although the subject matter described herein may be implemented in any appropriate type of system using any suitable components, the embodiments disclosed herein may also be described in relation to a wireless network, such as the example wireless network illustrated in FIG. 5. For simplicity, the wireless network of FIG. 5 only depicts network 506, network nodes 560 and 560b, and wireless devices 510, 510b, and 510c. In practice, a wireless network may further include any additional elements suitable to support communication between wireless devices or between a wireless device and another communication device, such as a landline telephone, a service provider, or any other network node or end device. Of the illustrated components, network node 560 and wireless device 510 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, 5G, 6G standards; wireless local area network (WLAN) standards, such as the IEEE 502.11 standards; and/or any other appropriate wireless communication standard, such as the Worldwide Interoperability for Microwave Access (WiMax), Bluetooth, Z-Wave and/or ZigBee standards.

Network 506 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 560 and wireless device 510 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs), and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTS. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 5, network node 560 includes processing circuitry 570, device readable medium 580, interface 590, auxiliary equipment 554, power source 556, power circuitry 557, and antenna 562. Although network node 560 illustrated in the example wireless network of FIG. 5 may represent a device that includes the illustrated combination of hardware components, other embodiments may comprise network nodes with different combinations of components. It is to be understood that a network node comprises any suitable combination of hardware and/or software to perform the tasks, features, functions and methods disclosed herein. Moreover, while the components of network node 560 are depicted as single boxes located within a larger box, or nested within multiple boxes, in practice, a network node may comprise multiple different physical components that make up a single illustrated component (e.g., device readable medium 580 may comprise multiple separate hard drives as well as multiple RAM modules).

Similarly, network node 560 may be composed of multiple physically separate components (e.g., a NodeB component and a RNC component, or a BTS component and a BSC component, etc.), which may each have their own respective components. In certain scenarios in which network node 560 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 560 may be configured to support multiple radio access technologies (RATS). In such embodiments, some components may be duplicated (e.g., separate device readable medium 580 for the different RATS) and some components may be reused (e.g., the same antenna 562 may be shared by the RATS). Network node 560 may also include multiple sets of the various illustrated components for different wireless technologies integrated into network node 560, such as, for example, GSM, code division multiple access (CDMA), wideband code division multiple access (WCDMA), LTE, NR, Wi-Fi, or Bluetooth wireless technologies. These wireless technologies may be integrated into the same or different chip or set of chips and other components within network node 560.

Processing circuitry 570 is configured to perform any determining, calculating, or similar operations (e.g., certain obtaining operations) described herein as being provided by a network node. These operations performed by processing circuitry 570 may include processing information obtained by processing circuitry 570 by, for example, converting the obtained information into other information, comparing the obtained information or converted information to information stored in the network node, and/or performing one or more operations based on the obtained information or converted information, and as a result of said processing making a determination.

Processing circuitry 570 may comprise a combination of one or more of a microprocessor, controller, microcontroller, central processing unit, DSP, application-specific integrated circuitry (ASIC), FPGA, or any other suitable computing device, resource, or combination of hardware, software and/or encoded logic operable to provide, either alone or in conjunction with other network node 560 components, such as device readable medium 580, network node 560 functionality. For example, processing circuitry 570 may execute instructions stored in device readable medium 580 or in memory within processing circuitry 570. Such functionality may include providing any of the various wireless features, functions, or benefits discussed herein. In some embodiments, processing circuitry 570 may include a system on a chip (SOC).

In some embodiments, processing circuitry 570 may include one or more of RF transceiver circuitry 572 and baseband processing circuitry 574. In some embodiments, RF transceiver circuitry 572 and baseband processing circuitry 574 may be on separate chips (or sets of chips), boards, or units, such as radio units and digital units. In alternative embodiments, part or all of RF transceiver circuitry 572 and baseband processing circuitry 574 may be on the same chip or set of chips, boards, or units. The embodiments described by this disclosure can be implemented for the network node 560 in the interface 590 and/or the processing circuitry 570. Further, the embodiments described by this disclosure can be implemented for the wireless device or user equipment 510 in the interface 514 and/or the processing circuitry 520.

In certain embodiments, some or all of the functionality described herein as being provided by a network node, base station, eNB or other such network device may be performed by processing circuitry 570 executing instructions stored on device readable medium 580 or memory within processing circuitry 570. In alternative embodiments, some or all of the functionalities may be provided by processing circuitry 570 without executing instructions stored on a separate or discrete device readable medium, such as in a hard-wired manner. In any of those embodiments, whether executing instructions stored on a device readable storage medium or not, processing circuitry 570 may be configured to perform the described functionality. The benefits provided by such functionality are not limited to processing circuitry 570 alone or to other components of network node 560 but are enjoyed by network node 560 as a whole, and/or by end users and the wireless network generally.

Device readable medium 580 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 570. Device readable medium 580 may store any suitable instructions, data or information, including a computer program, software, an application including one or more of logic, rules, code, tables, etc. and/or other instructions capable of being executed by processing circuitry 570 and, utilized by network node 560. Device readable medium 580 may be used to store any calculations made by processing circuitry 570 and/or any data received via interface 590. In some embodiments, processing circuitry 570 and device readable medium 580 may be integrated.

Interface 590 is used in the wired or wireless communication of signaling and/or data between network node 560, network 506, and/or wireless devices 510,410b, 510c. As illustrated, interface 590 comprises port(s)/terminal(s) 594 to send and receive data, for example to and from network 506 over a wired connection. Interface 590 also includes radio front end circuitry 592 that may be coupled to, or in certain embodiments a part of, antenna 562. Radio front end circuitry 592 comprises filters 598 and amplifiers 596. Radio front end circuitry 592 may be connected to antenna 562 and processing circuitry 570. Radio front end circuitry may be configured to condition signals communicated between antenna 562 and processing circuitry 570. Radio front end circuitry 592 may receive digital data that is to be sent out to other network nodes or wireless devices via a wireless connection. Radio front end circuitry 592 may convert the digital data into a radio signal having the appropriate channel and bandwidth parameters using a combination of filters 598 and/or amplifiers 596. The radio signal may then be transmitted via antenna 562. Similarly, when receiving data, antenna 562 may collect radio signals which are then converted into digital data by radio front end circuitry 592. The digital data may be passed to processing circuitry 570. In other embodiments, the interface may comprise different components and/or different combinations of components.

In certain alternative embodiments, network node 560 may not include separate radio front end circuitry 592, instead, processing circuitry 570 may comprise radio front end circuitry and may be connected to antenna 562 without separate radio front end circuitry 592. Similarly, in some embodiments, all or some of RF transceiver circuitry 572 may be considered a part of interface 590. In still other embodiments, interface 590 may include one or more ports or terminals 594, radio front end circuitry 592, and RF transceiver circuitry 572, as part of a radio unit (not shown), and interface 590 may communicate with baseband processing circuitry 574, which is part of a digital unit (not shown).

Antenna 562 may include one or more antennas, or antenna arrays, configured to send and/or receive wireless signals. Antenna 562 may be coupled to radio front end circuitry 590 and may be any type of antenna capable of transmitting and receiving data and/or signals wirelessly. In some embodiments, antenna 562 may comprise one or more omni-directional, sector or panel antennas operable to transmit/receive radio signals between, for example, 2 GHz and 56 GHz. An omni-directional antenna may be used to transmit/receive radio signals in any direction, a sector antenna may be used to transmit/receive radio signals from devices within a particular area, and a panel antenna may be a line-of-sight antenna used to transmit/receive radio signals in a relatively straight line. In some instances, the use of more than one antenna may be referred to as multiple-input multiple-output (MIMO). In certain embodiments, antenna 562 may be separate from network node 560 and may be connectable to network node 560 through an interface or port.

Antenna 562, interface 590, and/or processing circuitry 570 may be configured to perform any receiving operations and/or certain obtaining operations described herein as being performed by a network node. Any information, data and/or signals may be received from a wireless device, another network node and/or any other network equipment. Similarly, antenna 562, interface 590, and/or processing circuitry 570 may be configured to perform any transmitting operations described herein as being performed by a network node. Any information, data and/or signals may be transmitted to a wireless device, another network node and/or any other network equipment.

Power circuitry 587 may comprise, or be coupled to, power management circuitry and is configured to supply the components of network node 560 with power for performing the functionality described herein. Power circuitry 587 may receive power from power source 586. Power source 586 and/or power circuitry 587 may be configured to provide power to the various components of network node 560 in a form suitable for the respective components (e.g., at a voltage and current level for each respective component). Power source 586 may either be included in, or external to, power circuitry 587 and/or network node 560. For example, network node 560 may be connectable to an external power source (e.g., an electricity outlet) via an input circuitry or interface such as an electrical cable, whereby the external power source supplies power to power circuitry 587. As a further example, power source 586 may comprise a source of power in the form of a battery or battery pack which is connected to, or integrated in, power circuitry 587. The battery may provide backup power should the external power source fail. Other types of power sources, such as photovoltaic devices, may also be used.

Alternative embodiments of network node 560 may include additional components beyond those shown in FIG. 5 that may be responsible for providing certain aspects of the network node's functionality, including any of the functionality described herein and/or any functionality necessary to support the subject matter described herein. For example, network node 560 may include user interface equipment to allow input of information into network node 560 and to allow output of information from network node 560. This may allow a user to perform diagnostic, maintenance, repair, and other administrative functions for network node 560.

As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A wireless device may support device-to-device (D2D) communication, for example by implementing a 3rd Generation Partnership Project (3GPP) standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements and transmits the results of such monitoring and/or measurements to another wireless device and/or a network node. The wireless device may in this case be a machine-to-machine (M2M) device, which may in a 3GPP context be referred to as an MTC device. As one example, the wireless device may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 510 includes antenna 511, interface 514, processing circuitry 520, device readable medium 530, user interface equipment 532, auxiliary equipment 534, power source 536 and power circuitry 537. Wireless device 510 may include multiple sets of one or more of the illustrated components for different wireless technologies supported by wireless device 510, such as, for example, GSM, WCDMA, LTE, NR, Wi-Fi, WiMAX, NB-IoT, or Bluetooth wireless technologies, just to mention a few. These wireless technologies may be integrated into the same or different chips or set of chips as other components within wireless device 510.

Antenna 511 may include one or more antennas or antenna arrays, configured to send and/or receive wireless signals, and is connected to interface 514. In certain alternative embodiments, antenna 511 may be separate from wireless device 510 and be connectable to wireless device 510 through an interface or port. Antenna 511, interface 514, and/or processing circuitry 520 may be configured to perform any receiving or transmitting operations described herein as being performed by a wireless device. Any information, data and/or signals may be received from a network node and/or another wireless device. In some embodiments, radio front end circuitry and/or antenna 511 may be considered an interface.

As illustrated, interface 514 comprises radio front end circuitry 512 and antenna 511. Radio front end circuitry 512 comprise one or more filters 518 and amplifiers 516. Radio front end circuitry 512 is connected to antenna 511 and processing circuitry 520 and is configured to condition signals communicated between antenna 511 and processing circuitry 520. Radio front end circuitry 512 may be coupled to or a part of antenna 511. In some embodiments, wireless device 510 may not include separate radio front end circuitry 512; rather, processing circuitry 520 may comprise radio front end circuitry and may be connected to antenna 511. Similarly, in some embodiments, some or all of RF transceiver circuitry 522 may be considered a part of interface 514. Radio front end circuitry 512 may receive digital data that is to be sent out to other network nodes or wireless devices via a wireless connection. Radio front end circuitry 512 may convert the digital data into a radio signal having the appropriate channel and bandwidth parameters using a combination of filters 518 and/or amplifiers 516. The radio signal may then be transmitted via antenna 511. Similarly, when receiving data, antenna 511 may collect radio signals which are then converted into digital data by radio front end circuitry 512. The digital data may be passed to processing circuitry 520. In other embodiments, the interface may comprise different components and/or different combinations of components.

Processing circuitry 520 may comprise a combination of one or more of a microprocessor, controller, microcontroller, central processing unit, DSP, ASIC, FPGA, or any other suitable computing device, resource, or combination of hardware, software, and/or encoded logic operable to provide, either alone or in conjunction with other wireless device 510 components, such as device readable medium 530, wireless device 510 functionality. Such functionality may include providing any of the various wireless features or benefits discussed herein. For example, processing circuitry 520 may execute instructions stored in device readable medium 530 or in memory within processing circuitry 520 to provide the functionality disclosed herein.

As illustrated, processing circuitry 520 includes one or more RF transceiver circuitry 522, baseband processing circuitry 524, and application processing circuitry 526. In other embodiments, the processing circuitry may comprise different components and/or different combinations of components. In certain embodiments processing circuitry 520 of wireless device 510 may comprise a SOC. In some embodiments, RF transceiver circuitry 522, baseband processing circuitry 524, and application processing circuitry 526 may be on separate chips or sets of chips. In alternative embodiments, part or all of baseband processing circuitry 524 and application processing circuitry 526 may be combined into one chip or set of chips, and RF transceiver circuitry 522 may be on a separate chip or set of chips. In still alternative embodiments, part or all of RF transceiver circuitry 522 and baseband processing circuitry 524 may be on the same chip or set of chips, and application processing circuitry 526 may be on a separate chip or set of chips. In yet other alternative embodiments, part or all of RF transceiver circuitry 522, baseband processing circuitry 524, and application processing circuitry 526 may be combined in the same chip or set of chips. In some embodiments, RF transceiver circuitry 522 may be a part of interface 514. RF transceiver circuitry 522 may condition RF signals for processing circuitry 520.

In certain embodiments, some or all of the functionality described herein as being performed by a wireless device may be provided by processing circuitry 520 executing instructions stored on device readable medium 530, which in certain embodiments may be a computer-readable storage medium. In alternative embodiments, some or all of the functionalities may be provided by processing circuitry 520 without executing instructions stored on a separate or discrete device readable storage medium, such as in a hard-wired manner. In any of those embodiments, whether executing instructions stored on a device readable storage medium or not, processing circuitry 520 may be configured to perform the described functionality. The benefits provided by such functionality are not limited to processing circuitry 520 alone or to other components of wireless device 510 but are enjoyed by wireless device 510 as a whole, and/or by end users and the wireless network generally.

Processing circuitry 520 may be configured to perform any determining, calculating, or similar operations (e.g., certain obtaining operations) described herein as being performed by a wireless device. These operations, as performed by processing circuitry 520, may include processing information obtained by processing circuitry 520 by, for example, converting the obtained information into other information, comparing the obtained information or converted information to information stored by wireless device 510, and/or performing one or more operations based on the obtained information or converted information, and as a result of said processing making a determination.

Device readable medium 530 may be operable to store a computer program, software, an application including one or more of logic, rules, code, tables, etc. and/or other instructions capable of being executed by processing circuitry 520. Device readable medium 530 may include computer memory (e.g., RAM or ROM), mass storage media (e.g., a hard disk), removable storage media (e.g., CD, DVD), and/or any other volatile or non-volatile, non-transitory device readable and/or computer executable memory devices that store information, data, and/or instructions that may be used by processing circuitry 520. In some embodiments, processing circuitry 520 and device readable medium 530 may be integrated.

User interface equipment 532 may provide components that allow for a human user to interact with wireless device 510. Such interaction may be of many forms, such as visual, audial, tactile, etc. User interface equipment 532 may be operable to produce output to the user and to allow the user to provide input to wireless device 510. The type of interaction may vary depending on the type of user interface equipment 532 installed in wireless device 510. For example, if wireless device 510 is a smart phone, the interaction may be via a touch screen; if wireless device 510 is a smart meter, the interaction may be through a screen that provides usage (e.g., the number of gallons used) or a speaker that provides an audible alert (e.g., if smoke is detected). User interface equipment 532 may include input interfaces, devices and circuits, and output interfaces, devices and circuits. User interface equipment 532 is configured to allow input of information into wireless device 510 and is connected to processing circuitry 520 to allow processing circuitry 520 to process the input information. User interface equipment 532 may include, for example, a microphone, a proximity or other sensor, keys/buttons, a touch display, one or more cameras, a USB port, or other input circuitry. User interface equipment 532 is also configured to allow output of information from wireless device 510, and to allow processing circuitry 520 to output information from wireless device 510. User interface equipment 532 may include, for example, a speaker, a display, vibrating circuitry, a USB port, a headphone interface, or other output circuitry. Using one or more input and output interfaces, devices, and circuits, of user interface equipment 532, wireless device 510 may communicate with end users and/or the wireless network, and allow them to benefit from the functionality described herein.

Auxiliary equipment 534 is operable to provide more specific functionality which may not be generally performed by wireless devices. This may comprise specialized sensors for performing measurements for various purposes, interfaces for additional types of communication such as wired communications etc. The inclusion and type of components of auxiliary equipment 534 may vary depending on the embodiment and/or scenario.

Power source 536 may, in some embodiments, be in the form of a battery or battery pack. Other types of power sources, such as an external power source (e.g., an electricity outlet), photovoltaic devices or power cells, may also be used. The wireless device 510 may further comprise power circuitry 537 for delivering power from power source 536 to the various parts of wireless device 510 which need power from power source 536 to carry out any functionality described or indicated herein. Power circuitry 537 may in certain embodiments comprise power management circuitry. Power circuitry 537 may additionally or alternatively be operable to receive power from an external power source; in which case wireless device 510 may be connectable to the external power source (such as an electricity outlet) via input circuitry or an interface such as an electrical power cable. Power circuitry 537 may also, in certain embodiments, be operable to deliver power from an external power source to power source 536. This may be, for example, for the charging of power source 536. Power circuitry 537 may perform any formatting, converting, or other modification to the power from power source 536 to make the power suitable for the respective components of wireless device 510 to which power is supplied.

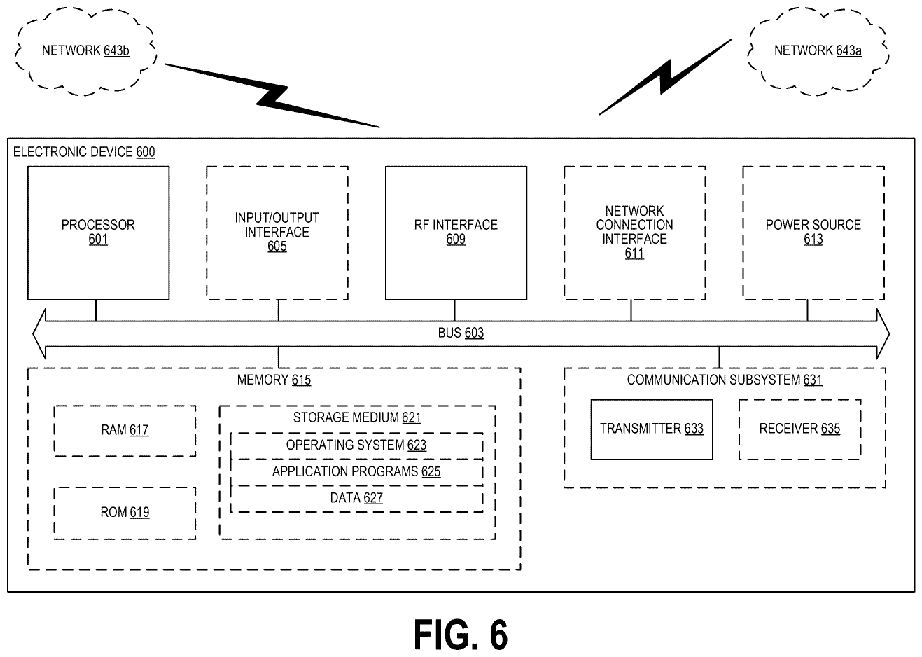

FIG. 6 illustrates one embodiment of an electronic device 600 in accordance with various aspects described herein. As used herein, device 600 can be a wired device, wireless device or both. Further, device 600 may not necessarily have a user in the sense of a human user who owns and/or operates the relevant device. Instead, device 600 may represent a device that is intended for sale to, or operation by, a human user but which may not, or which may not initially, be associated with a specific human user (e.g., a smart sprinkler controller, IoT device). Alternatively, device 600 may represent a device that is not intended for sale to, or operation by, an end user but which may be associated with or operated for the benefit of a user (e.g., a smart power meter). Device 600 may be UE identified by the 3GPP, including a NB-IoT UE, a machine type communication (MTC) UE, and/or an enhanced MTC (eMTC) UE. Device 600, as illustrated in FIG. 6, is one example of a device configured for wired or wireless communication in accordance with one or more communication standards such as promulgated by the 3GPP, such as 3GPP's GSM, UMTS, LTE, and/or 6G standards.

Device 600 can include any electronic device that has an amplifier. In one example, device 600 can include an audio or music device, home audio system, stereo amplifier, audio or video receiver, home theater system, powered speaker, subwoofer, karaoke machine, musical equipment, guitar amplifier, bass amplifier, keyboard amplifier, public address system, studio monitor, headphone or earbud, noise-canceling headphone, portable audio device, Bluetooth speaker, portable amplifier for headphones or instrument, or the like. In another example, device 600 can include a wireless device, user equipment, network node, base station, broadcast or communication device, radio transmitter, wireless communication equipment, satellite communication system, Wi-Fi router, extended range device, telecommunication device, microwave repeater, radar system, or the like. In yet another example, device 600 can include consumer electronics, televisions, internal audio amplifier for a speaker, external soundbar with built-in amplifier, computer or gaming device, sound card with integrated amplifier, DAC with amplifier, smartphone, tablet, built-in audio amplifier for speaker or headphone, or the like. In yet another example, device 600 can include automotive or transportation device, car audio system, car amplifier, subwoofer amplifier, marine audio system, amplifier for boat or watercraft, aircraft communication system, amplifier for cockpit communication or in-flight entertainment, or the like. In yet another example, device 600 can include industrial and professional equipment, public address system, amplifier for a large venue, school or stadium, concert or event equipment, power amplifier for a loudspeaker, line array system, medical equipment, ultrasound machine, hearing aids, or the like. In yet another example, device 600 can include RF or specialized equipment, RF amplifier, signal booster for a cell tower, satellite uplink or downlink device, test or measurement instrument, oscilloscope, spectrum analyzer, military or aerospace equipment, radar system, communication jammer, or the like. In yet another example, device 600 can include toy or hobby device, radio-controlled car, plane or drone, smart home device, smart speaker, voice assistant device, or the like.

In FIG. 6, device 600 includes processing circuitry 601 that is operatively coupled to input/output interface 605, RF interface 609, network connection interface 611, memory 615 including RAM 617, ROM 619, and storage medium 621 or the like, communication subsystem 631, power source 613, and/or any other component, or any combination thereof. Storage medium 621 includes operating system 623, application program 625, and data 627. In other embodiments, storage medium 621 may include other similar types of information. Certain electronic devices may utilize all of the components shown in FIG. 6, or only a subset of the components. The level of integration between the components may vary from one device to another device. Further, certain electronic devices may contain multiple instances of a component, such as multiple processors, memories, transceivers, transmitters, receivers, etc.

In FIG. 6, processing circuitry 601 may be configured to process computer instructions and data. Processing circuitry 601 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or DSP, together with appropriate software; or any combination of the above. For example, the processing circuitry 601 may include two central processing units (CPUs). Data may be information in a form suitable for use by a computer.

In the depicted embodiment, input/output interface 605 may be configured to provide a communication interface to an input device, output device, or input and output device. Device 600 may be configured to use an output device via input/output interface 605. An output device may use the same type of interface port as an input device. For example, a USB port may be used to provide input to and output from device 600. The output device may be a speaker, a sound card, a video card, a display, a monitor, a printer, an actuator, an emitter, a smartcard, another output device, or any combination thereof. Device 600 may be configured to use an input device via input/output interface 605 to allow a user to capture information into device 600. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, or an optical sensor.

In FIG. 6, RF interface 609 may be configured to provide a communication interface to RF components such as a transmitter, a receiver, and an antenna. Network connection interface 611 may be configured to provide a communication interface to network 643a. Network 643a may encompass wired and/or wireless networks such as a local-area network (LAN), a wide-area network (WAN), a computer network, a wireless network, a telecommunications network, another like network or any combination thereof. For example, network 643a may comprise a Wi-Fi network. Network connection interface 611 may be configured to include a receiver and a transmitter interface used to communicate with one or more other devices over a communication network according to one or more communication protocols, such as Ethernet, TCP/IP, synchronous optical networking (SONET), asynchronous transfer mode (ATM), or the like. Network connection interface 611 may implement receiver and transmitter functionality appropriate to the communication network links (e.g., optical, electrical, and the like). The transmitter and receiver functions may share circuitry components, software or firmware, or alternatively may be implemented separately.

RAM 617 may be configured to interface via bus 602 to processing circuitry 601 to provide storage or caching of data or computer instructions during the execution of software programs such as the operating system, application programs, and device drivers. ROM 619 may be configured to provide computer instructions or data to processing circuitry 601. For example, ROM 619 may be configured to store invariant low-level system code or data for basic system functions such as basic input and output (I/O), startup, or reception of keystrokes from a keyboard that are stored in a non-volatile memory. Storage medium 621 may be configured to include memory such as RAM, ROM, programmable ROM (PROM), erasable PROM (EPROM), electrically erasable PROM (EEPROM), magnetic disks, optical disks, floppy disks, hard disks, removable cartridges, or flash drives. In one example, storage medium 621 may be configured to include operating system 623, application program 625 such as a web browser application, a widget or gadget engine or another application, and data file 627. Storage medium 621 may store, for use by device 600, any of a variety of various operating systems or combinations of operating systems.

Storage medium 621 may be configured to include a number of physical drive units, such as redundant array of independent disks (RAID), floppy disk drive, flash memory, USB flash drive, external hard disk drive, thumb drive, pen drive, key drive, high-density DVD (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 621 may allow device 600 to access computer-executable instructions, application programs or the like, stored on transitory or non-transitory memory media, to off-load data, or to upload data. An article of manufacture, such as one utilizing a communication system may be tangibly embodied in storage medium 621, which may comprise a device readable medium.

In FIG. 6, processing circuitry 601 may be configured to communicate with network 643b using communication subsystem 631. Network 643a and network 643b may be the same network or networks or different network or networks. Communication subsystem 631 may be configured to include one or more transceivers used to communicate with network 643b. For example, communication subsystem 631 may be configured to include one or more transceivers used to communicate with one or more remote transceivers of another device capable of wireless communication such as another electronic device, wireless device, UE, or base station of a radio access network (RAN) according to one or more communication protocols, such as IEEE 802.11, CDMA, WCDMA, GSM, LTE, UMTS terrestrial radio access network (UTRAN), WiMax, or the like. Each transceiver may include transmitter 633 and/or receiver 635 to implement transmitter or receiver functionality, respectively, appropriate to the RAN links (e.g., frequency allocations and the like). Further, transmitter 633 and receiver 635 of each transceiver may share circuitry components, software or firmware, or alternatively may be implemented separately.

In the illustrated embodiment, the communication functions of communication subsystem 631 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 631 may include cellular communication, Wi-Fi communication, Bluetooth communication, and GPS communication. Network 643b may encompass wired and/or wireless networks such as a LAN, a WAN, a computer network, a wireless network, a telecommunications network, another like network or any combination thereof. For example, network 643b may be a cellular network, a Wi-Fi network, and/or a near-field network. Power source 613 may be configured to provide alternating current (AC) or direct current (DC) power to components of device 600.

The features, benefits and/or functions described herein may be implemented in one of the components of device 600 or partitioned across multiple components of device 600. Further, the features, benefits, and/or functions described herein may be implemented in any combination of hardware, software or firmware. In one example, communication subsystem 631 may be configured to include any of the components described herein. Further, processing circuitry 601 may be configured to communicate with any of such components over bus 602. In another example, any of such components may be represented by program instructions stored in memory that when executed by processing circuitry 601 perform the corresponding functions described herein. In another example, the functionality of any of such components may be partitioned between processing circuitry 601 and communication subsystem 631. In another example, the non-computationally intensive functions of any of such components may be implemented in software or firmware and the computationally intensive functions may be implemented in hardware. The embodiments described by this disclosure can be implemented for the device 600 in the RF interface block 609 or the transmitter block 633 of the communication subsystem 631.

Those skilled in the art will also appreciate that embodiments herein further include corresponding computer programs.

A computer program comprises instructions which, when executed on at least one processor of an apparatus, cause the apparatus to carry out any of the respective processes described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts for illustrative purposes, but the embodiments are similarly applicable in other contexts not explicitly described.

In one exemplary embodiment, a method of performing quantized digital amplification with reduced number of bandpass modulators includes: receiving as input signal samples sₙ of a baseband signal sₙ=s(tₙ)=s_{I,n}+js_{Q,n}, where s_{In} and s_{Qn} represent the sample of the in-phase and quadrature-phase component respectively, and tₙ is the sampling instant; receiving clock reference signals associated with a carrier frequency (f_{c}), a sampling rate fₛ and an intermediate frequency fᵢ; computing for each sample the values

$${A}_{n} = \sqrt{{s}_{I , n}^{2} + {s}_{Q , n}^{2}} , {α}_{n} = A TAN ( {s}_{Q , n} / {s}_{I , n} ) ,$$

and quantizing Aₙ based on the set of N_{b} quantization bit as A_{qn}=An+e_{q}, where e_{q} denotes the quantization error and based on quantization error e_{q} computing a compensation factor Δ belonging to a finite discrete alphabet; generating a puncturing encoding table of quantization bits by puncturing quantization bits and generating a punctured mapping table with the puncturing mapping rule; generating in a punctured mapper a set of N′≤N_{b} active pairs of in-phase and quadrature-phase mapping components according to the punctured mapping table that contains the mapping components values with puncturing of components; generating control information to disable punctured mapping components and control information to enable selection of components to be amplified, synchronization and switching control; delivering the N′ active pairs of in-phase and quadrature-phase mapping components to a set of bandpass modulators to generate a punctured set of N′ active bandpass components at carrier frequency f_{c}; or amplifying the N′ active bandpass components in N′ active amplifiers.

In another exemplary embodiment, the method step of receiving the input signal can include receiving samples sₙ of a baseband signal s(t) and generating the samples s_{In} and s_{Qn} of the in-phase and quadrature-phase components.

In another exemplary embodiment, the method step of receiving the input signal can include receiving a baseband signal and sampling it in a sampling circuitry or in a sample and hold (S/H) circuitry to generate samples of the input signal.

In another exemplary embodiment, the method step of receiving the input signal can include receiving samples of in-phase and quadrature-phase components of a baseband signal.

In another exemplary embodiment, the method step of receiving the clock reference signals can further include receiving clock reference signals associated with a carrier frequency f_{c} and a sampling rate fₛ.

In another exemplary embodiment, a quantizer circuitry can be operable to quantize the input signal sample based on a quantization encoding table having N_{b} bits, a table having a finite set of quantization values, a table having the discrete amplitudes of quantization components aᵢ={a₁, a₂, . . . , a_{Nb}} in which the quantized value can be decomposed, a punctured quantization encoding table, or the like.

In another exemplary embodiment, a LUT circuitry can be configured to store the mapping table having the mapping component values according to a puncturing rule, the quantization bit combinations, the sets of discrete amplitudes aᵢ, the set of quantized values, or the like.

In another exemplary embodiment, the punctured mapper circuitry can be operable to select, based on the quantization bits and punctured encoding table, the mapping coefficients Cₖ, k=1, . . . , N_{b}, needed to map the quantized value into N′≤N_{b} pairs of in-phase s_{I,n} and quadrature-phase s_{Q,n}, mapping components given by Cₖ cos(an) and Cₖ sin(an) with k=1, . . . , N_{b}, and in which amplitude of mapping coefficients Cₖ assume values from N_{b} discrete alphabets.

In another exemplary embodiment, the punctured mapper circuitry can be operable to apply the punctured mapping rule to generate control information to activate the mapping of the set of mapping components into the set of bandpass components and to control switches to activate or deactivate power amplifiers operable to amplify the bandpass components.

In another exemplary embodiment, the set of bandpass modulator circuitry can include a set of N′ I/Q modulators or a set of N′ I/Q DACs.

In another exemplary embodiment, a set of N′ bandpass modulator circuitry can be operable to generate the set of N′ active bandpass components at the intermediate frequency fᵢ and a set of N′ mixers operable to up-convert the set of N′ active bandpass components to the carrier frequency f_{c}.

In another exemplary embodiment, the punctured mapper circuitry can be operable to provide information to control the initial phase of the set of bandpass components generated by the set of bandpass modulator circuitry, which can be performed by changing the phases or delays of the inputs at the beginning of each sampling interval.

In another exemplary embodiment, the method step of generating the control information can include generating control information to control a combiner circuitry electrically coupled to the outputs of the set of power amplifiers and operable to combine the set of amplified bandpass signals.

In another exemplary embodiment, the method steps of computing the amplitude Aₙ, quantizing the amplitude Aₙ, generating the punctured quantization encoding table, generating the punctured mapping rule and punctured mapping can be performed in a single step based on a LUT circuitry having the corresponding quantization values, puncturing quantization encoding rule, punctured mapping rules, and control information.

In another exemplary embodiment, when N_{b} is an odd number, the maximum number of active mapping components is

$$N ’ = \frac{{N}_{b} + 1}{2}$$

and the maximum number of bandpass modulators is reduced to N′, and when N_{b} is even the maximum number of active mapping components is

$$N ’ = \frac{{N}_{b}}{2}$$

and the maximum number of bandpass modulators is also reduced to

$$\frac{{N}_{b}}{2} .$$

In another exemplary embodiment, the method can further include combining the punctured set of N′ active bandpass components based on the digital control information that defines which components are active.

In another exemplary embodiment, the punctured mapper can associate with each bandpass modulator more than two different sets of mapping coefficients corresponding to the possible bandpass components that can be generated by each bandpass modulator.

In one exemplary embodiment, an apparatus includes: a first circuitry operable to receive input signal samples sₙ of a baseband signal sₙ=s(tₙ)=s_{I,n}+js_{Q,n}, where s_{In} and s_{Qn} represent the sample of the respective in-phase and quadrature-phase component and to is the sampling instant; a second circuitry operable to receives a clock reference signal associated with a carrier frequency f_{c}, a clock reference signal associated with a sampling rate fₛ and a clock reference signal associated with an intermediate frequency f; a quantizer encoding circuitry operable to compute, for each sample sₙ, an amplitude Aₙ and a phase αₙ of the input signal sample based on a quantization encoding table having N_{b} quantization bits for each quantized value, a table having a finite set of quantization values and a table having the sets of discrete amplitudes of quantization components aᵢ={a₁, a₂, . . . , a_{Nb}} in which the quantized value can be decomposed, and the set of quantized values, to determine the quantized amplitude A_{qn}=Aₙ+e_{q}, to compute the set of quantization bits, and to compute a compensation factor Δ belonging to a finite discrete alphabet based quantization error e_{q}; a punctured encoder circuitry operable to generate a punctured encoding table based on the quantization encoding table; a punctured mapper circuitry operable to generate, based on the set of quantization bits that represent the quantized amplitude Aₙ, the amplitude Aₙ, the phase αₙ, the compensation factor Δ, the amplitudes aᵢ and the punctured encoding table, the punctured mapping table that represents the puncturing mapping rule and to generates a set of N′≤N_{b} active set of pairs of in-phase and quadrature-phase mapping components by selecting the mapping values of the corresponding mapping components based on the punctured mapping table, with the coefficients Cₖ, k=1, . . . , N_{b} to map the quantized value into N′≤N_{b} pairs of in-phase s_{I,n} and quadrature-phase s_{Q,n} mapping components given by Cₖ cos(aₙ) and Cₖ sin(aₙ) with k=1, . . . , N_{b}; or a set of N′ bandpass modulator circuitry operable to generate, based on the active set of N′ pairs of in-phase and quadrature-phase mapping components, generate the punctured set of bandpass components at a carrier frequency f_{c}; and a set of N′ amplifier circuitry operable to amplify the punctured set of bandpass components to obtain an output signal.

In another exemplary embodiment, an input circuitry can be operable to sample an input signal to obtain the in-phase and quadrature-phase samples s_{In} and s_{Qn}.

In another exemplary embodiment, an input circuitry can be operable to receive the samples s_{In} and s_{Qn} of the in-phase and quadrature-phase components of a baseband signal.

In another exemplary embodiment, the quantization encoder circuitry, the punctured mapper circuitry, the set of bandpass modulator circuitry, the set of power amplifiers or the combiner circuitry can be operable to receive the clock reference signals.

In another exemplary embodiment, the punctured mapper circuitry can be operable to provide information to the digital control circuitry to enable generation of the digital control signals to activate or deactivate the power amplifier circuitry, activate or deactivate the bandpass modulator circuitry, the mixer circuitry and the inputs of the combiner circuitry.

In another exemplary embodiment, when N_{b}=3, the punctured mapping table can include a set of mapping coefficients Cₖ, k=1, . . . , 3 and

$$N ’ = \frac{{N}_{b} + 1}{2} = two ( 2 )$$

bandpass modulator circuitry; C₁ mapping coefficient can assume values from a set of amplitudes

$${C}_{1}^{( i )} ,$$

i=1, . . . , 6, that belong to a discrete alphabet A₁ with possible values of

$$\{ 0 , Δ , {a}_{1} + Δ , {a}_{1} + \frac{{a}_{1}}{{a}_{2} {+}_{1}} Δ \} ,$$

where Δ is the discrete compensation factor with values belonging to a discrete and finite alphabet and amplitudes a₁ and a₂ defined to enable an improved power relationship between components to increase efficiency and assumes different values belonging to a discrete and limited set of possible values; C₂ mapping coefficient can assume values from a set of amplitudes

$${C}_{2}^{( i )} ,$$

i=1, . . . , 8, belonging to a discrete alphabet A₂ with possible values of

$$\{ 0 , {a}_{2} + Δ , {a}_{2} + \frac{{a}_{2}}{{a}_{2} + {a}_{1}} Δ , {a}_{2} + \frac{{a}_{2}}{{a}_{3} + {a}_{2}} Δ , {a}_{2} + \frac{{a}_{2}}{{a}_{3} + {a}_{2}} ( Δ + {a}_{1} ) \} ,$$

with amplitudes a₁, a₂ and a₃ defined to enable an improved power relationship between components to increase efficiency and can assume different values always belonging to a discrete and limited set of possible values; C₃ mapping coefficient can assume values from a set of amplitudes

$${C}_{3}^{( i )} ,$$

i=1, . . . , 8, belonging to a discrete alphabet A₃ with possible values of

$$\{ 0 , {a}_{3} + Δ , {a}_{3} + Δ + {a}_{1} , {a}_{3} + \frac{{a}_{3}}{{a}_{3} + {a}_{2}} Δ , {a}_{3} + \frac{{a}_{3}}{{a}_{3} + {a}_{2}} ( Δ + {a}_{1} ) \} ,$$

where amplitudes a₁, a₂ and a₃ are defined to improve efficiency and can assume different values belonging to a finite discrete set of possible values; a single bandpass modulator circuitry operable to generate bandpass components associated with the C₁ or C₃ mapping coefficients, and a single bandpass modulator circuitry operable to generate a bandpass component associated with the C₂ mapping coefficient.

In another exemplary embodiment, when Nb=4, the punctured mapping table can include a set of mapping coefficients Cₖ, k=1, . . . , 4 and

$${N}^{′} = \frac{{N}_{b}}{2} = two ( 2 )$$

bandpass modulator circuitry; C₁ mapping coefficient can assume values from a set of amplitudes

$${C}_{1}^{( i )} ,$$

i=1, . . . , 10, that belong to a discrete alphabet A₁ with possible values of

$$\{ 0 , Δ , {a}_{1} + Δ , {a}_{1} + \frac{{a}_{1}}{{a}_{2} + {a}_{1}} Δ \} ,$$

where Δ is the discrete compensation factor with values belonging to a discrete and finite alphabet, and amplitudes a₁ and a₂ defined to enable an improved power relationship between components to increase energy efficiency; C₂ mapping coefficient can assume values from a set of amplitudes

$${C}_{2}^{( i )} ,$$

i=1, . . . , 12 belonging to a discrete alphabet A₂ with possible values of

$$\{ 0 , {a}_{2} + Δ , {a}_{2} + \frac{{a}_{2}}{{a}_{2} + {a}_{1}} Δ , {a}_{2} + \frac{{a}_{2}}{{a}_{3} + {a}_{2}} Δ , {a}_{2} + \frac{{a}_{2}}{{a}_{3} + {a}_{2}} ( Δ + {a}_{1} ) \} ,$$

with amplitudes a₁, a₂ and a₃ defined to enable the best power relation between components to maximize energy efficiency; C₃ mapping coefficient assuming values from a set of amplitudes

$${C}_{3}^{( i )} ,$$

i=1, . . . , 16 belonging to a discrete alphabet A₃ with possible values of

$$\{ 0 , {a}_{3} + Δ , {a}_{3} + Δ + {a}_{1} , {a}_{3} + \frac{{a}_{3}}{{a}_{4} + {a}_{3}} Δ , {a}_{3} + \frac{{a}_{3}}{{a}_{4} + {a}_{3}} ( Δ + {a}_{1} ) , {a}_{3} + \frac{{a}_{3}}{{a}_{4} + {a}_{3}} Δ , {a}_{3} + \frac{{a}_{3}}{{a}_{4} + {a}_{3}} ( Δ + {a}_{1} ) , {a}_{3} + \frac{{a}_{3}}{{a}_{4} + {a}_{3}} ( Δ + {a}_{2} ) , {a}_{3} + \frac{{a}_{3}}{{a}_{4} + {a}_{3}} ( Δ + {a}_{1} + {a}_{2} ) \} ,$$

where amplitudes a₁, a₂, a₃ and a₄ are defined to enable the best power relation between components in order to maximize energy efficiency; C₄ mapping coefficient assuming values from a set of amplitudes

$${C}_{4}^{( i )} ,$$

i=1, . . . , 16 belonging to a discrete alphabet A₄ with possible values of

$$\{ 0 , {a}_{4} + Δ , {a}_{4} + Δ + {a}_{1} , {a}_{4} + Δ + {a}_{2} , {a}_{4} + Δ + {a}_{2} + {a}_{1} , {a}_{4} + \frac{{a}_{4}}{{a}_{4} + {a}_{3}} Δ , {a}_{4} + \frac{{a}_{4}}{{a}_{4} + {a}_{3}} ( Δ + {a}_{1} ) , {a}_{4} + \frac{{a}_{4}}{{a}_{4} + {a}_{3}} ( Δ + {a}_{2} ) , {a}_{4} + \frac{{a}_{4}}{{a}_{4} + {a}_{3}} ( Δ + {a}_{1} + {a}_{2} ) \} ,$$

where amplitudes a₁, a₂, a₃ and a₄ are defined to enable an improved power relationship between components in order to increase energy efficiency; a single bandpass modulator circuitry can be operable to generate a bandpass component associated with a C₁ or C₃ mapping coefficient and a single bandpass modulator circuitry can be operable to generate a bandpass component associated with a C₂ or C₄ mapping coefficient.

In another exemplary embodiment, for N_{b} being an even number of bits, the punctured mapping table can include a set of coefficients Cₖ, k=1, . . . , N_{b} having values belonging to N_{b} discrete alphabets Aₖ, k=1, . . . , N_{b}; N′=N_{b}/2 bandpass modulators can be operable to generate two different bandpass components based on the mapping coefficients provided by the punctured mapper circuitry, with only one bandpass component being active according to the punctured mapping rule.

In another exemplary embodiment, for N_{b} being an odd number of bits, the punctured mapping table can include a set of coefficients Cₖ, k=1, . . . , N_{b} having values belonging to N_{b} discrete alphabets Aₖ, k=1, . . . , N_{b}; N′=N_{b}/2−1 bandpass modulator circuitry can be operable to generate two different bandpass components according to the mapping coefficients provided by the punctured mapper circuitry, with only one bandpass component being active according to the punctured mapping rule; a single bandpass modulator circuitry can be operable to generate one bandpass component according to the mapping coefficients provided by the punctured mapper circuitry.

In another exemplary embodiment, a LUT circuitry can be configured to store the punctured mapping table, the punctured coding table, the quantization encoding table, the quantization values table or the quantization amplitude components table. Further, the LUT circuitry can be accessible by the quantizer circuitry, the punctured encoder circuitry, the punctured mapper circuitry, or the like.

In another exemplary embodiment, the set of bandpass modulator circuitry can include I/Q modulator circuitry having two outputs or I/Q DACs having two outputs, with each output being electrically coupled to one of the set of power amplifier circuitry associated with the bandpass mapping component of that output.

In another exemplary embodiment, the set of bandpass modulator circuitry can include I/Q modulator circuitry having one output or I/Q DAC circuitry having one output, with each output being electrically coupled to a switch circuitry operable to select one of the set of power amplifier circuitry that is associated with the active bandpass component of that output.

In another exemplary embodiment, the set of bandpass modulator circuitry can be operable to generate the punctured set of N′ active bandpass components at the intermediate frequency fᵢ and the set of mixer circuitry can be operable to up-convert the punctured set of N′ active bandpass components to the carrier RF frequency f_{c}.

In another exemplary embodiment, each bandpass modulator circuitry can be associated with more than two different sets of mapping coefficients corresponding to the possible bandpass components that can be generated by that bandpass modulator circuitry.

In another exemplary embodiment, the punctured mapper circuitry, the quantizer encoding circuitry, the set of mixer circuitry and the set of bandpass modulator circuitry can be implemented in hardware, software or firmware, including digital or analog techniques, with or without microprocessors, FPGAs and DSPs.

In another exemplary embodiment, the set of switch circuitry can be electrically coupled to the set of power amplifiers and controlled by a control signal that includes information associated with which bandpass component is active or inactive and the corresponding amplification branch.

In another exemplary embodiment, the control circuitry can be further operable to generate control information to activate or deactivate the set of mixer circuitry, control the set of switch circuitry, or activate or deactivate the set of power amplifier circuitry that corresponds to the active mapping components.

In another exemplary embodiment, the punctured mapper circuitry can be operable to receive, from the set of bandpass modulator circuitry, the feedback signals and generate phase or time control information for the set of bandpass modulator circuitry to enable time or phase synchronization of the punctured set of bandpass components at the outputs of the set of mixer circuitry or the set of power amplifier circuitry.

In another exemplary embodiment, the punctured mapper circuitry can be operable to receive, from the outputs of the set of power amplifier circuitry, feedback signals and generate time or phase control information for the set of bandpass modulator circuitry to enable time or phase synchronization of the punctured set of bandpass components at the outputs of the set of power amplifier circuitry.

In another exemplary embodiment, the punctured mapper circuitry can be operable to receive, from the outputs of the set of mixer circuitry, feedback signals to enable time or phase synchronization of the punctured set of bandpass components and the set of amplified bandpass components.

In another exemplary embodiment, when N_{b} is an odd number, the maximum number of the set of bandpass modulator circuitry is

$${N}^{′} = \frac{{N}_{b} + 1}{2}$$

and when N_{b} is even, the maximum number of the set of bandpass modulator circuitry is

$${N}^{′} = \frac{{N}_{b}}{2} .$$

In another exemplary embodiment, a combiner circuitry can be operable to receive a punctured set of bandpass components that enables the digital control information to activate or deactivate the inputs to the combiner circuitry and enables the control information associated with the time or phase synchronization determined by the punctured mapper circuitry.

In another exemplary embodiment, the punctured mapper circuitry can be operable to correct, based on received feedback signals, the information associated with the amplitude or phase to enable synchronization of the set of amplified bandpass components combined by the combiner circuitry.

In one exemplary embodiment, a method is performed by a user equipment device having a set of power amplifier circuitry operable to collectively amplify an input signal having information. The method includes outputting, by a circuitry electrically coupled to the set of power amplifier circuitry, a punctured set of bandpass components that collectively represents a sample of the input signal. Further, the punctured set of bandpass components corresponds to the set of power amplifier circuitry and is associated with a quantized polar representation of the input signal sample.

In another exemplary embodiment, each bandpass component is associated with one of a set of quantization bits that represents a quantized amplitude of the polar representation of the sample.

In another exemplary embodiment, at least one power amplifier circuitry is configured to output power that is linearly proportional to another of the set of power amplifier circuitry or at least one power amplifier circuitry is configured to output power that is non-linearly proportional to another of the set of power amplifier circuits.

In another exemplary embodiment, the set of bandpass components includes a certain IF or RF frequency signal.

In another exemplary embodiment, each bandpass component corresponds to one of the set of power amplifier circuitry, one of a set of quantization bits that represents a quantized amplitude of the polar representation of the sample, or a phase of the polar representation of the input sample.

In one exemplary embodiment, a user equipment device includes a set of power amplifier circuitry operable to collectively amplify an input signal having information and a circuitry electrically coupled to the set of power amplifier circuitry and operable to output a punctured set of bandpass components that collectively represents a sample of the input signal. Further, the punctured set of bandpass components corresponds to the set of power amplifier circuitry and is associated with a quantized polar representation of the input signal sample.

In one exemplary embodiment, a method is performed by a user equipment device having a set of power amplifier circuitry. The method includes amplifying, by the set of power amplifier circuitry, a set of output signals that collectively represents an amplified sample of an input signal having information. Further, the set of output signals corresponds to a punctured set of bandpass components that collectively represents the input signal sample and is associated with a quantized polar representation of the input signal sample.

In one exemplary embodiment, a user equipment device includes a set of power amplifier circuitry operable to amplify a set of output signals that collectively represents an amplified sample of an input signal having information. Further, the set of output signals corresponds to a punctured set of bandpass components that collectively represents the input signal sample and is associated with a quantized polar representation of the input signal sample.

The previous detailed description is merely illustrative in nature and is not intended to limit the present disclosure, or the application and uses of the present disclosure. Furthermore, there is no intention to be bound by any expressed or implied theory presented in the preceding field of use, background, summary, or detailed description. The present disclosure provides various examples, embodiments and the like, which may be described herein in terms of functional or logical block elements. The various aspects described herein are presented as methods, devices (or apparatus), systems, or articles of manufacture that may include a number of components, elements, members, modules, nodes, peripherals, or the like. Further, these methods, devices, systems, or articles of manufacture may include or not include additional components, elements, members, modules, nodes, peripherals, or the like.

Furthermore, the various aspects described herein may be implemented using standard programming or engineering techniques to produce software, firmware, hardware (e.g., circuits), or any combination thereof to control a computing device to implement the disclosed subject matter. It will be appreciated that some embodiments may be comprised of one or more generic or specialized processors such as microprocessors, digital signal processors, customized processors and FPGAs and unique stored program instructions (including both software and firmware) that control the one or more processors to implement, in conjunction with certain non-processor circuits, some, most, or all of the functions of the methods, devices and systems described herein. Alternatively, some or all functions could be implemented by a state machine that has no stored program instructions, or in one or more application specific integrated circuits (ASICs), in which each function or some combinations of certain of the functions are implemented as custom logic circuits. Of course, a combination of the two approaches may be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a CD or DVD; a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a LAN. Of course, a person of ordinary skill in the art will recognize many modifications may be made to this configuration without departing from the scope or spirit of the subject matter of this disclosure.

Throughout the specification and the embodiments, the following terms take at least the meanings explicitly associated herein, unless the context clearly dictates otherwise. Relational terms such as “first” and “second,” and the like may be used solely to distinguish one entity or action from another entity or action without necessarily requiring or implying any actual such relationship or order between such entities or actions. The term “or” is intended to mean an inclusive “or” unless specified otherwise or clear from the context to be directed to an exclusive form. Further, the terms “a,” “an,” and “the” are intended to mean one or more unless specified otherwise or clear from the context to be directed to a singular form. The term “include” and its various forms are intended to mean including but not limited to. References to “one embodiment,” “an embodiment,” “example embodiment,” “various embodiments,” and other like terms indicate that the embodiments of the disclosed technology so described may include a particular function, feature, structure, or characteristic, but not every embodiment necessarily includes the particular function, feature, structure, or characteristic. Further, repeated use of the phrase “in one embodiment” does not necessarily refer to the same embodiment, although it may. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

What is claimed is:

1. A method, comprising:
by a user equipment device having a set of power amplifier circuitry operable to collectively amplify an input signal having information,
outputting, by a circuitry electrically coupled to the set of power amplifier circuitry, a punctured set of bandpass components that collectively represents a sample of the input signal, with the punctured set of bandpass components corresponding to the set of power amplifier circuitry and being associated with a quantized polar representation of the input signal sample.

2. The method of claim 1, wherein each bandpass component is associated with one of a set of quantization bits that represents a quantized amplitude of the polar representation of the sample.

3. The method of claim 1, wherein at least one power amplifier circuitry is configured to output power that is linearly proportional to another of the set of power amplifier circuitry or at least one power amplifier circuitry is configured to output power that is non-linearly proportional to another of the set of power amplifier circuits.

4. The method of claim 1, wherein the set of bandpass components includes a certain intermediate frequency (IF) or radio frequency (RF) frequency signal.

5. The method of claim 1, wherein each bandpass component corresponds to one of the set of power amplifier circuitry, one of a set of quantization bits that represents a quantized amplitude of the polar representation of the sample, and a phase of the polar representation of the input sample.

6. A user equipment device, comprising:
a set of power amplifier circuitry operable to collectively amplify an input signal having information; and
a circuitry electrically coupled to the set of power amplifier circuitry and operable to output a punctured set of bandpass components that collectively represents a sample of the input signal, with the punctured set of bandpass components corresponding to the set of power amplifier circuitry and being associated with a quantized polar representation of the input signal sample.

7. The device of claim 6, wherein each bandpass component is associated with one of a set of quantization bits that represents a quantized amplitude of the polar representation of the sample.

8. The device of claim 6, wherein at least one power amplifier circuitry is configured to output power that is linearly proportional to another of the set of power amplifier circuitry or at least one power amplifier circuitry is configured to output power that is non-linearly proportional to another of the set of power amplifier circuits.

9. The device of claim 6, wherein the set of bandpass components includes a certain intermediate frequency (IF) or radio frequency (RF) frequency signal.

10. The device of claim 6, wherein each bandpass component corresponds to one of the set of power amplifier circuitry, one of a set of quantization bits that represents a quantized amplitude of the polar representation of the sample, and a phase of the polar representation of the input sample.

11. A method, comprising:
by a user equipment device having a set of power amplifier circuitry; and
amplifying, by the set of power amplifier circuitry, a set of output signals that collectively represents an amplified sample of an input signal having information, with the set of output signals corresponding to a punctured set of bandpass components that collectively represents the input signal sample and is associated with a quantized polar representation of the input signal sample.

12. The method of claim 11, wherein each bandpass component is associated with one of a set of quantization bits that represents a quantized amplitude of the polar representation of the sample.

13. The method of claim 11, wherein at least one power amplifier circuitry is configured to output power that is linearly proportional to another of the set of power amplifier circuitry or at least one power amplifier circuitry is configured to output power that is non-linearly proportional to another of the set of power amplifier circuits.

14. The method of claim 11, wherein the set of bandpass components includes a certain intermediate frequency (IF) or radio frequency (RF) frequency signal.

15. The method of claim 11, wherein each bandpass component corresponds to one of the set of power amplifier circuitry, one of a set of quantization bits that represents a quantized amplitude of the polar representation of the sample, and a phase of the polar representation of the input sample.

16. A user equipment device, comprising:
a set of power amplifier circuitry operable to amplify a set of output signals that collectively represents an amplified sample of an input signal having information, with the set of output signals corresponding to a punctured set of bandpass components that collectively represents the input signal sample and is associated with a quantized polar representation of the input signal sample.

17. The device of claim 16, wherein each bandpass component is associated with one of a set of quantization bits that represents a quantized amplitude of the polar representation of the sample.

18. The device of claim 16, wherein at least one power amplifier circuitry is configured to output power that is linearly proportional to another of the set of power amplifier circuitry or at least one power amplifier circuitry is configured to output power that is non-linearly proportional to another of the set of power amplifier circuits.

19. The device of claim 16, wherein the set of bandpass components includes a certain intermediate frequency (IF) or radio frequency (RF) frequency signal.

20. The device of claim 16, wherein each bandpass component corresponds to one of the set of power amplifier circuitry, one of a set of quantization bits that represents a quantized amplitude of the polar representation of the sample, and a phase of the polar representation of the input sample.
